(19) United States
(12) Patent Application Publication
(10) Pub. No.: US 2025/0067624 A1
(43) Pub. Date: Feb. 27, 2025

(54) GAS SENSOR

(71) Applicant: NGK INSULATORS, LTD., Nagoya-shi (JP)

(72) Inventors: Yuya SEIKE, Nagoya-shi (JP); Kohei YAITA, Nagoya-shi (JP); Satoru SHIRAISHI, Nagoya-shi (JP); Shintaro MAKI, Nagoya-shi (JP)

(21) Appl. No.: 18/798,905

(22) Filed: Aug. 9, 2024

(30) Foreign Application Priority Data
Aug. 22, 2023 (JP) 2023-134593

(51) Int. Cl. G01M 15/10

(52) U.S. Cl. CPC G01M 15/104

(57) ABSTRACT

Provided is a gas sensor that prevents a ceramic housing from biting into a member arranged on a rear end side of the ceramic housing in a state of being inclined from an axial direction. In the gas sensor according to one aspect of the present invention, a spacer having Young's modulus of 80 GPa or more is arranged at least in a front end portion on a rear end side of the ceramic housing to which a terminal fitting is attached.

### CROSS-REFERENCE TO RELATED APPLICATION

The present application claims priority from Japanese application JP 2023-134593, filed on Aug. 22, 2023, the contents of which is hereby incorporated by reference into this application.

### FIELD OF INVENTION

The present invention relates to a gas sensor.

### BACKGROUND

Conventionally, a gas sensor that detects concentration of specific gas such as oxygen or NOx in measured gas such as exhaust gas of an automobile is known. For example, JP 2014-196917 A below discloses a gas sensor including a tubular body in which a sensor element and a connector (ceramic housing) to which a contact fitting electrically conducted with the sensor element is attached are arranged, and an elastic body that seals an opening end of the tubular body. In the gas sensor disclosed in JP 2014-196917 A, an elastic body is arranged on the rear end side in an axial direction of the gas sensor (axial direction of the sensor element) of the ceramic housing.

### SUMMARY of INVENTION

The present inventors have found that, with respect to the conventional gas sensor as disclosed in JP 2014-196917 A, a problem below occurs in a case where the ceramic housing is fixed in a state of being inclined from the axial direction inside the tubular body. That is, in a case where the ceramic housing is fixed in a state of being inclined from the axial direction, unintended stress (for example, stress in a direction other than a direction orthogonal to the axial direction) acts from the sensor element on the terminal fitting attached to the ceramic housing and connected to the sensor element. For this reason, the present inventors have found a problem that in a case where the ceramic housing is fixed in a state of being inclined from the axial direction in the gas sensor, when an impact is applied to the gas sensor, the terminal fitting is more likely to break than a case where the ceramic housing is fixed in parallel to the axial direction.

The present inventors have further studied and identified that an event that the ceramic housing is fixed in a state of being inclined from the axial direction occurs, for example, as described below. That is, in the conventional gas sensor, the elastic body arranged on the rear end side of the ceramic housing and sealing an opening end of the tubular body has Young's modulus lower than that of the ceramic housing, that is, is softer than the ceramic housing. For this reason, the present inventors have identified that the above-described event occurs when the ceramic housing bites into an elastic body softer than the ceramic housing in a state of being inclined from the axial direction in, for example, a manufacturing stage of a gas sensor.

As described above, the present inventors have found a problem that when the ceramic housing bites into a member (for example, an elastic body) arranged on the rear end side of the ceramic housing in a state where the ceramic housing is inclined from the axial direction, the terminal fitting attached to the ceramic housing is easily broken.

The present invention has been made in view of such circumstances in one aspect, and an object of the present invention is to provide a gas sensor in which a ceramic housing is prevented from biting into a member arranged on the rear end side of the ceramic housing in a state of being inclined from an axial direction.

In order to solve the above-described problem, the present invention employs a configuration below.

A gas sensor according to a first aspect includes a sensor element that extends in an axial direction, has a detection unit on a front end side, and has a connector electrode on a rear end side, a terminal fitting that extends in the axial direction and has an element contact portion electrically connected to the connector electrode on a front end side, a ceramic housing that houses the connector electrode and the element contact portion, a tubular body in which the sensor element, the terminal fitting, and the ceramic housing are arranged, and an opening end is formed, an elastic body arranged to seal the opening end, and a spacer that is arranged between the ceramic housing and the elastic body in the axial direction, is in contact with the ceramic housing at an end surface on a front end side in the axial direction, is in contact with the elastic body at an end surface on a rear end side in the axial direction, and has Young's modulus of 80 GPa or more at least at a front end portion including an end surface on the front end side.

In the configuration, in the gas sensor, the ceramic housing is in contact with the front end portion of the spacer arranged on the rear end side of the ceramic housing, the front end portion having Young's modulus of 80 GPa or more.

The present inventors have considered that it is possible to prevent the ceramic housing from biting into the elastic body by arranging the spacer between the ceramic housing and the elastic body. In view of the above, in the gas sensor, the spacer is arranged between the ceramic housing and the elastic body.

The present inventors have further considered that in order to prevent the ceramic housing from biting into a member arranged on the rear end side of the ceramic housing, it is effective to sufficiently harden a portion on the front end side in the axial direction of the member arranged on the rear end side. Here, as described above, in the gas sensor, the spacer is arranged between the ceramic housing and the elastic body. In view of the above, in order to prevent the ceramic housing from biting into the spacer (in particular, the front end portion of the spacer), the present inventors have determined, by experiment, hardness (softness) to be given to the front end portion of the spacer. As a result, the present inventors have confirmed that by setting Young's modulus of the front end portion of the spacer to 80 GPa or more, it is possible to remarkably prevent the ceramic housing from biting into the spacer (in particular the front end portion) as compared with a case where the Young's modulus is set to be less than 80 GPa.

In the gas sensor, the ceramic housing is in contact with the spacer arranged on the rear end side of the ceramic housing, particularly, an end surface on the front end side of the spacer. Then, Young's modulus of the front end portion including an end surface on the front end side of the spacer is 80 GPa or more, which is sufficient hardness capable of remarkably preventing the ceramic housing from biting into the spacer (in particular the front end portion).

For this reason, in the gas sensor, an event such as that “the ceramic housing bites into the spacer arranged on the rear end side of the ceramic housing in a state of being inclined from the axial direction, and such a state is fixed” does not occur.

Therefore, the gas sensor achieves an effect of being able to prevent the ceramic housing from biting into a member (that is, the spacer) arranged on the rear end side of the ceramic housing in a state of being inclined from the axial direction.

A gas sensor according to a second aspect is the gas sensor according to the first aspect, in which, in the spacer, Young's modulus of a rear end portion including an end surface on the rear end side may be smaller than Young's modulus of the front end portion. In the configuration, in the gas sensor, Young's modulus of a rear end portion including an end surface on the rear end side of the spacer is smaller than Young's modulus of the front end portion. That is, in the gas sensor, the rear end portion of the spacer is softer and more easily bent than the front end portion of the spacer. Then, in the gas sensor, the spacer is in contact with the elastic body at an end surface on the rear end side in the axial direction.

Therefore, in the gas sensor, when an end surface (front end surface) on the front end side in the axial direction of the elastic body is inclined with respect to the axial direction, inclination of the front end surface of the elastic body can be absorbed in the rear end portion of the spacer. That is, the gas sensor can absorb inclination of the front end surface of the elastic body at the rear end portion of the spacer as the soft rear end portion of the spacer in contact with the front end surface of the elastic body is bent.

The spacer prevents “inclination of the front end surface of the elastic body from being transmitted to the ceramic housing via the spacer, and the ceramic housing from being inclined from the axial direction” by the rear end portion that is softer and more easily bent than the front end portion. For example, in a case where the front end surface of the elastic body is inclined from the axial direction, stress in a direction inclined from the axial direction may be transmitted from the front end surface of the elastic body to the ceramic housing, and the ceramic housing may be inclined from the axial direction due to such stress. The spacer prevents such an event by the rear end portion which is softer and more easily bent than the front end portion. That is, the spacer prevents occurrence of an event in which the ceramic housing is inclined from the axial direction due to stress in a direction inclined from the axial direction from the front end surface of the elastic body by absorbing the stress by the rear end portion. Moreover, the front end portion of the spacer has sufficient hardness that can remarkably prevent the ceramic housing from biting into the spacer.

Therefore, the gas sensor achieves an effect of being able to more effectively prevent the ceramic housing from biting into a member (that is, the spacer) arranged on the rear end side of the ceramic housing in a state of being inclined from the axial direction.

A gas sensor according to a third aspect is the gas sensor according to the first or second aspect, in which a contact area between the spacer and the ceramic housing may be 3 mm² or more. In the configuration, in the gas sensor, a contact area between the spacer and the ceramic housing is 3 mm² or more.

The present inventors have considered that it is effective to sufficiently secure a contact area (hereinafter referred to as “contact area A1”) between the spacer and the ceramic housing in order to prevent the ceramic housing from being fixed in a state of being inclined from the axial direction. For example, it is considered that when the contact area A1 is small, force is likely to act in a direction inclined from the axial direction from the spacer to the ceramic housing as compared with a case where the contact area A1 is large, and as a result, the ceramic housing is likely to be inclined from the axial direction. Further, it is considered that when the contact area A1 is small, contact between the spacer and the ceramic housing is not stable as compared with a case where the contact area A1 is large, and as a result, the ceramic housing is likely to be inclined from the axial direction, for example, in a case where an impact is applied to the gas sensor. In view of the above, the present inventors have verified a range of the contact area A1 between the spacer and the ceramic housing effective for preventing the ceramic housing from being fixed in a state of being inclined from the axial direction. As a result, the present inventors have confirmed that by setting the contact area A1 to 3 mm² or more, it is possible to remarkably prevent the ceramic housing from being fixed in a state of being inclined from the axial direction as compared with a case of setting the contact area A1 to less than 3 mm².

In the gas sensor, the contact area (contact area A1) between the spacer and the ceramic housing is 3 mm² or more. Therefore, the gas sensor achieves an effect of being able to remarkably prevent the ceramic housing from being fixed in a state of being inclined from the axial direction as compared with a case where the contact area A1 between the spacer and the ceramic housing is less than 3 mm².

Here, the gas sensor is manufactured through, for example, a process below. That is, first, a contact member in which the ceramic housing to which the terminal fitting is attached, the spacer, and the elastic body are arranged in this order from the front end side in the axial direction is prepared (preliminary assembly). At a time point of the preliminary assembly, a “fixing fitting including a pressing spring” and a “swaging ring” to be described later do not need to be assembled to an outer periphery of the ceramic housing yet. After the preliminary assembly is completed, the rear end side of the sensor element is then inserted into the ceramic housing (in particular, an insertion port provided on the front end side of the ceramic housing) to which the terminal fitting is attached. Then, the sensor element and the ceramic housing (contact member) are integrated by swaging a swaging ring provided to fix the ceramic housing into which the sensor element is inserted from an outer periphery.

However, if the ceramic housing is inclined from the axial direction at a time point of the preliminary assembly, the ceramic housing is integrated with the sensor element in the inclined state, that is, the state in which the ceramic housing is inclined from the axial direction is fixed.

In view of the above, for example, by sufficiently securing the contact area A1 between the spacer and the ceramic housing at a time point of the preliminary assembly, it is possible to prevent the ceramic housing from being positioned in a state of being inclined from the axial direction in the contact member described above. Specifically, by setting the contact area A1 to 3 mm² or more at a time point of the preliminary assembly, the gas sensor can prevent occurrence of an event in which “the ceramic housing is positioned in a state of being inclined from the axial direction at a time point of the preliminary assembly”.

A gas sensor according to a fourth aspect is the gas sensor according to any of first to third aspects, in which an area of a portion in contact with the spacer in an end surface on the front end side of the elastic body may be 25% or more of an entire area of an end surface on the front end side of the elastic body. In the configuration, in the gas sensor, an area of a portion in contact with the spacer in an end surface on the front end side of the elastic body is 25% or more of an entire area of an end surface on the front end side of the elastic body.

The present inventors have considered that it is effective to sufficiently secure a contact area (hereinafter referred to as “contact area A2”) between the spacer and the elastic body in order to prevent the ceramic housing from being fixed in a state of being inclined from the axial direction. For example, it is considered that when the contact area A2 is small, force is likely to act in a direction inclined from the axial direction from the elastic body to the spacer as compared with a case where the contact area A2 is large, and as a result, the ceramic housing in contact with the spacer is also likely to be inclined from the axial direction. Further, when the contact area A2 is small, contact between the elastic body and the spacer is not stable as compared with a case where the contact area A2 is large, and it is considered that the spacer (in particular, an end surface of the spacer) is likely to be inclined from the axial direction, for example, in a case where an impact is applied to the gas sensor and the like. Then, it is considered that as the spacer (in particular, an end surface of the spacer) is inclined from the axial direction, the ceramic housing in contact with the spacer (in particular, an end surface on the front end side of the spacer) is also likely to be inclined from the axial direction. In view of the above, the present inventors have verified a range of the contact area A2 between the spacer and the elastic body effective for preventing the ceramic housing from being fixed in a state of being inclined from the axial direction. The present inventors have confirmed that by setting the contact area A2 to 25% or more of an entire area of an end surface on the front end side of the elastic body, it is possible to remarkably prevent the ceramic housing from being fixed in a state of being inclined from the axial direction, as compared with a case where the contact area A2 is set to less than 25%.

In the gas sensor, an area of a portion in contact with the spacer in an end surface on the front end side of the elastic body, that is, the contact area A2 described above, is 25% or more of an entire area of an end surface on the front end side of the elastic body.

Therefore, the gas sensor achieves an effect of being able to remarkably prevent the ceramic housing from being fixed in a state of being inclined from the axial direction as compared with a case where the contact area A2 is less than 25% of an entire area of an end surface on the front end side of the elastic body.

Here, the gas sensor is manufactured through, for example, a process below. That is, the gas sensor is manufactured through a swaging process of swaging the elastic body arranged at the opening end of the tubular body and the tubular body in a diameter reducing manner to fix the elastic body to the opening end and seal the opening end with the elastic body. In this swaging process, there is a possibility that the elastic body is deformed and stress acts on the spacer in a direction inclined from the axial direction. For example, in the swaging process, there is a possibility that a front end surface of the elastic body is pushed out to the front end side in the axial direction in a state of being inclined from the axial direction, and applies stress in a direction inclined from the axial direction to the spacer. When the contact area A2 between the spacer and the elastic body is small at a time point of the swaging process, the spacer is not stabilized since the elastic body is soft, and stress acts in a direction inclined from the axial direction on the spacer from the elastic body, and the spacer is likely to be inclined from the axial direction. Then, as the spacer (in particular, a front end surface of the spacer) is inclined from the axial direction, there is a possibility that the ceramic housing in contact with the spacer is also inclined from the axial direction.

In view of the above, for example, by sufficiently securing the contact area A2 between the spacer and the elastic body in the above-described swaging process, the gas sensor can prevent the ceramic housing from being inclined from the axial direction. Specifically, by setting the contact area A2 to 25% or more of an entire area of an end surface of the front end side of the elastic body in the swaging process, the gas sensor can prevent occurrence of an event in which “the ceramic housing is inclined from the axial direction in the swaging process”.

A gas sensor according to a fifth aspect is the gas sensor according to any of the first to fourth aspects, in which a distance from a position of the center of gravity of a portion in contact with the ceramic housing on an end surface on the front end side of the spacer, which is the center of mass when mass is virtually uniformly distributed to a portion in contact with the ceramic housing on an end surface on the front end side of the spacer, to a straight line obtained by extending an axis of the sensor element in the axial direction may be within 2 mm. In the configuration, in the gas sensor, a distance (hereinafter referred to as “distance L1”) from a position of the center of gravity (hereinafter referred to as “center of gravity CG1”) of a portion of the spacer in contact with the ceramic housing to a straight line obtained by extending the axis in the axial direction is within 2 mm.

The present inventors have considered that it is effective to bring the spacer and the ceramic housing into contact with each other on a straight line obtained by extending the axis in the axial direction (that is, the extension line of the axis) in order to prevent the ceramic housing from being fixed in a state of being inclined from the axial direction. In particular, the present inventors have considered that, if the distance L1 from the center of gravity CG1 of a contact surface between the spacer and the ceramic housing to the extension line of the axis can be sufficiently reduced, the ceramic housing can be effectively prevented from being fixed in a state of being inclined from the axial direction. In view of the above, the present inventors have verified the distance L1 from the center of gravity CG1 to the extension line of the axis, which is effective for preventing the ceramic housing from being fixed in a state of being inclined from the axial direction. As a result, the present inventors have confirmed that by setting the distance L1 from the center of gravity CG1 to the extension line of the axis to be within 2 mm, it is possible to remarkably prevent the ceramic housing from being fixed in a state of being inclined from the axial direction as compared with a case where the distance L1 is set to be larger than 2 mm.

In the gas sensor, a distance (that is, the distance L1) from a position of the center of gravity (that is, the center of gravity CG1) of a portion of the spacer in contact with the ceramic housing to the extension line of the axis is within 2 mm.

Therefore, the gas sensor achieves an effect of being able to remarkably prevent the ceramic housing from being fixed in a state of being inclined from the axial direction as compared with a case where the distance L1 from the center of gravity CG1 to the extension line of the axis is larger than 2 mm.

The gas sensor is manufactured, for example, through the preliminary assembly process described above. However, if the ceramic housing is inclined from the axial direction at a time point of the preliminary assembly, the ceramic housing is integrated with the sensor element in the inclined state, that is, the state in which the ceramic housing is inclined from the axial direction is fixed.

In view of the above, for example, by bringing the spacer and the ceramic housing into contact with each other on the extension line of the axis at a time point of the preliminary assembly, it is possible to prevent the ceramic housing from being positioned in a state of being inclined from the axial direction in the contact member. Specifically, at a time point of the preliminary assembly, the distance L1 from the center of gravity CG1 of a contact surface between the spacer and the ceramic housing to the extension line of the axis is set to be within 2 mm. By the above, the gas sensor can prevent occurrence of an event in which “the ceramic housing is positioned in a state of being inclined from the axial direction at a time point of the preliminary assembly”.

A gas sensor according to a sixth aspect is the gas sensor according to any of the first to fifth aspects, in which a distance from a position of a center of gravity of a portion in contact with the spacer on an end surface on the front end side of the elastic body, which is a center of mass when mass is virtually uniformly distributed to a portion in contact with the spacer on an end surface on the front end side of the elastic body, to a straight line obtained by extending an axis of the sensor element in the axial direction may be within 2 mm. In the configuration, in the gas sensor, a distance (hereinafter referred to as “distance L2”) from a position of the center of gravity (hereinafter referred to as “center of gravity CG2”) of a portion of the elastic body in contact with the space to a straight line obtained by extending the axis in the axial direction is within 2 mm.

The present inventors have considered that it is effective to bring the elastic body and the spacer into contact with each other on a straight line obtained by extending the axis in the axial direction (that is, the extension line of the axis) in order to prevent the ceramic housing from being fixed in a state of being inclined from the axial direction. In particular, the present inventors have considered that, if the distance L2 from the center of gravity CG2 of a contact surface between the elastic body and the spacer to the extension line of the axis can be sufficiently reduced, the ceramic housing can be effectively prevented from being fixed in a state of being inclined from the axial direction. In view of the above, the present inventors have verified the distance L2 from the center of gravity CG2 to the extension line of the axis, which is effective for preventing the ceramic housing from being fixed in a state of being inclined from the axial direction. As a result, the present inventors have confirmed that by setting the distance L2 from the center of gravity CG2 to the extension line of the axis to be within 2 mm, it is possible to remarkably prevent the ceramic housing from being fixed in a state of being inclined from the axial direction as compared with a case where the distance L2 is set to be larger than 2 mm.

In the gas sensor, a distance (that is, the distance L2) from a position of the center of gravity (that is, the center of gravity CG2) of a portion of the elastic body in contact with the space to a straight line obtained by extending the axis in the axial direction is within 2 mm.

Therefore, the gas sensor achieves an effect of being able to remarkably prevent the ceramic housing from being fixed in a state of being inclined from the axial direction as compared with a case where the distance L2 from the center of gravity CG2 to the extension line of the axis is larger than 2 mm.

The gas sensor is manufactured through, for example, the swaging process described above. However, when the elastic body is deformed in the swaging process and stress acts in a direction inclined from the axial direction from the elastic body to the spacer, as a result, the ceramic housing in contact with the spacer may also be inclined from the axial direction.

In view of the above, for example, by bringing the elastic body and the spacer into contact with each other on the extension line of the axis in the swaging process, the gas sensor can prevent the ceramic housing from being inclined from the axial direction. Specifically, in the swaging process, the distance L2 from the center of gravity CG2 to the extension line of the axis is set to be within 2 mm. By the above, the gas sensor can prevent occurrence of an event in which “the ceramic housing is positioned in a state of being inclined from the axial direction in the swaging process”.

A gas sensor according to a seventh aspect is the gas sensor according to any of the first to sixth aspects, in which a material of the elastic body is fluororubber. In the configuration, in the gas sensor, a material of the elastic body is fluororubber that has excellent performance in various aspects such as resistance and strength, and is particularly excellent in heat resistance and oil resistance. For this reason, the gas sensor achieves an effect of being able to maintain and improve detection accuracy of gas concentration by securing sealability of the elastic body under a high-temperature environment, for example.

A gas sensor according to an eighth aspect is the gas sensor according to any of the first to seventh aspects, in which at least a portion of the spacer may be made from ceramics. In the configuration, in the gas sensor, at least a portion of the spacer is made from ceramics having excellent heat resistance and generally having a higher melting point than resin. In the gas sensor, the spacer is arranged further on the front end side in the axial direction than the elastic body. When at least one portion of the spacer is made from ceramics having excellent heat resistance, the gas sensor achieves an effect below. That is, the gas sensor achieves an effect of being able to prevent occurrence of an event in which at least a portion of the spacer is eroded by heat generated from a heat source on the front end side of the gas sensor.

According to the present invention, a gas sensor that prevents a ceramic housing from biting into a member arranged on a rear end side of the ceramic housing in a state of being inclined from an axial direction can be provided.

### BRIEF DESCRIPTION OF DRAWINGS

FIG. 1 is a schematic cross-sectional view schematically illustrating an example of a main configuration of a gas sensor according to an embodiment;

FIG. 2 is an enlarged cross-sectional view of a main part illustrating the rear end side of the gas sensor illustrated in FIG. 1 in an enlarged manner;

FIG. 3 is a schematic cross-sectional view schematically illustrating an example of a main configuration of the gas sensor according to a first variation;

FIG. 4 is a schematic cross-sectional view schematically illustrating an example of a main configuration of the gas sensor according to a second variation; and

FIG. 5 is a graph showing a change in temperature and acceleration in a durability performance comparison test.

### DETAILED DESCRIPTION OF THE PREFERRED EMBODIMENTS

Hereinafter, an embodiment (hereinafter, also referred to as “the present embodiment”) according to one aspect of the present invention will be described with reference to the drawings. However, the present embodiment described below is merely an example of the present invention in all respects. It goes without saying that various improvements and modifications can be made without departing from the scope of the present invention. That is, in carrying out the present invention, a specific configuration according to an embodiment may be appropriately employed.

The present inventors have found that a problem below occurs in a case where the ceramic housing to which the contact fitting is attached is fixed in a state of being inclined from the axial direction in the conventional gas sensor in which the elastic body is arranged on the rear end side in the axial direction of the sensor element of the ceramic housing. That is, in a case where the ceramic housing is fixed in a state of being inclined from the axial direction, unintended stress (for example, stress in a direction other than a direction orthogonal to the axial direction) acts from the sensor element on the terminal fitting attached to the ceramic housing. For this reason, the present inventors have found a problem that in a case where the ceramic housing is fixed in a state of being inclined from the axial direction in the gas sensor, when an impact is applied to the gas sensor, the terminal fitting is more likely to break than a case where the ceramic housing is fixed in parallel to the axial direction.

The present inventors have further studied and identified that an event that the ceramic housing is fixed in a state of being inclined from the axial direction occurs, for example, as described below. That is, the present inventors have identified that the above-described event occurs when the ceramic housing bites into an elastic body softer than the ceramic housing in a state of being inclined from the axial direction in a manufacturing stage of a gas sensor.

The conventional gas sensor is manufactured, for example, through a preliminary assembly process below. That is, first, a contact member in which the ceramic housing to which the terminal fitting is attached and the elastic body are arranged in this order from a front end side in the axial direction is prepared (preliminary assembly step). Next, the rear end side of the sensor element is inserted into the contact member (in particular, an insertion port provided on the front end side of the ceramic housing). Then, the sensor element and the ceramic housing (contact member) are integrated by swaging a swaging ring provided to fix the ceramic housing into which the sensor element is inserted from an outer periphery.

Note that, in the present embodiment, an end surface on a front end side in an axial direction (axial direction of a sensor element) of each member is also referred to as a “front end surface”. Similarly, an end surface on the rear end side in the axial direction of each member is also referred to as a “rear end surface”.

In the conventional gas sensor manufactured through such a process, the ceramic housing may bite into an elastic body softer than the ceramic housing in a state of being inclined from the axial direction at the time of the preliminary assembly process. In such a case, in a subsequent step of integrating the sensor element and the ceramic housing, the state in which the ceramic housing is inclined from the axial direction is fixed. That is, the ceramic housing is integrated with the sensor element in the inclined state, and the state in which the ceramic housing is inclined from the axial direction is fixed.

Further, the conventional gas sensor is manufactured, for example, through a swaging process below in addition to the above-described preliminary assembly process. That is, the sensor element is manufactured through a swaging process of swaging, in a diameter reducing manner, a tubular body in which the sensor element and the contact member integrated with the sensor element are arranged and the elastic body arranged at an opening end of the tubular body. In the swaging process, the elastic body is fixed to the opening end of the tubular body, and the opening end of the tubular body is sealed by the elastic body.

In this swaging process, the soft elastic body for sealing the opening end of the tubular body may be deformed, and the elastic body (in particular, an end surface on the front end side in the axial direction) may apply stress to the ceramic housing in a direction inclined from the axial direction. For example, in the swaging process, a front end surface of the elastic body is pushed out to the front end side in the axial direction in a state of being inclined from the axial direction, and stress in a direction inclined from the axial direction may be applied to the ceramic housing.

The present inventors have confirmed that, for example, in a manufacturing stage of a gas sensor or the like (specifically, the preliminary assembly process, the swaging process, and the like described above), the ceramic housing may bite into the elastic body in a state of being inclined from the axial direction, and the state may be fixed.

In view of the above, the inventors of the present invention have considered preventing “a ceramic housing from biting into an elastic body softer than the ceramic housing in a state of being inclined from an axial direction” by using a spacer. That is, the present inventors have considered that by arranging a spacer between a ceramic housing to which a terminal fitting is attached and a soft elastic body that seals an opening end of a tubular body, it is possible to prevent the ceramic housing from biting into the elastic body in a state of being inclined from an axial direction. Furthermore, the present inventors have considered that it is effective to sufficiently harden a portion on the front end side in the axial direction of the spacer in order to prevent the ceramic housing from biting into the spacer arranged on the rear end side of the ceramic housing.

In order to prevent the ceramic housing from biting into the spacer (in particular, a front end portion of the spacer), the present inventors have determined, by experiment, hardness (softness) to be given to the front end portion of the spacer (for details of the experiment, see [Example] described later). As a result, the present inventors have confirmed that by setting Young's modulus of the front end portion of the spacer to 80 GPa or more, it is possible to remarkably prevent the ceramic housing from biting into the spacer (in particular a front end portion of the spacer) as compared with a case where the Young's modulus is set to be less than 80 GPa.

In view of the above, a gas sensor according to one aspect of the present invention includes a spacer between a ceramic housing to which a terminal fitting is attached and a soft elastic body that seals an opening end of a tubular body. Then, in the gas sensor according to one aspect of the present invention, the ceramic housing is in contact with the spacer arranged on the rear end side of the ceramic housing, particularly, an end surface (front end surface) on the front end side of the spacer. In the gas sensor according to one aspect of the present invention, Young's modulus of a front end portion including the front end surface of the spacer is 80 GPa or more, that is, the front end portion of the spacer has sufficient hardness that can significantly prevent the ceramic housing from biting into the spacer (in particular a front end portion of the spacer).

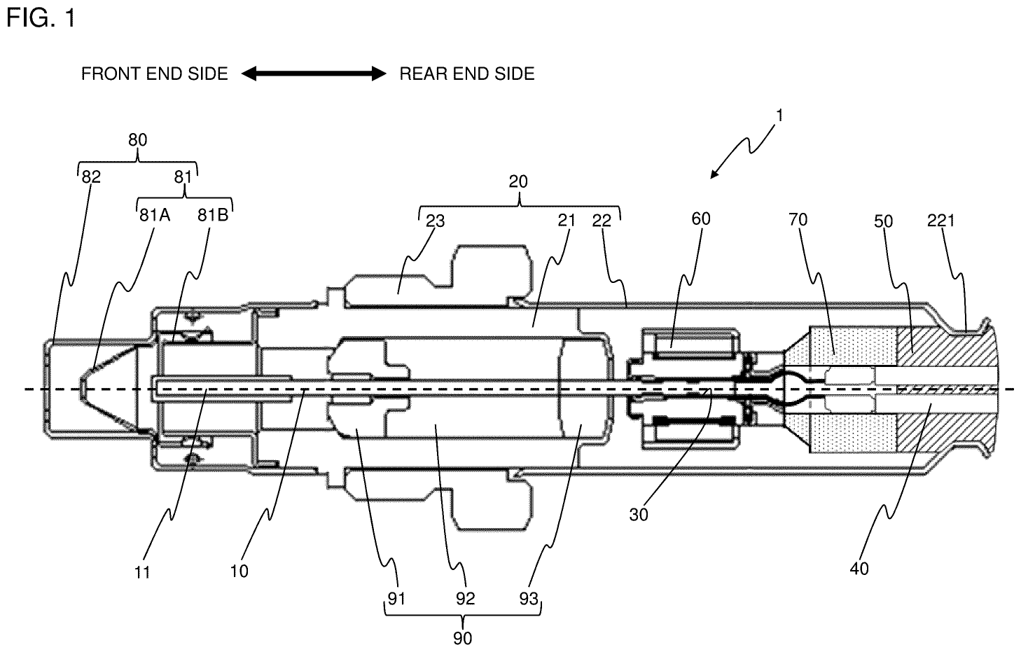

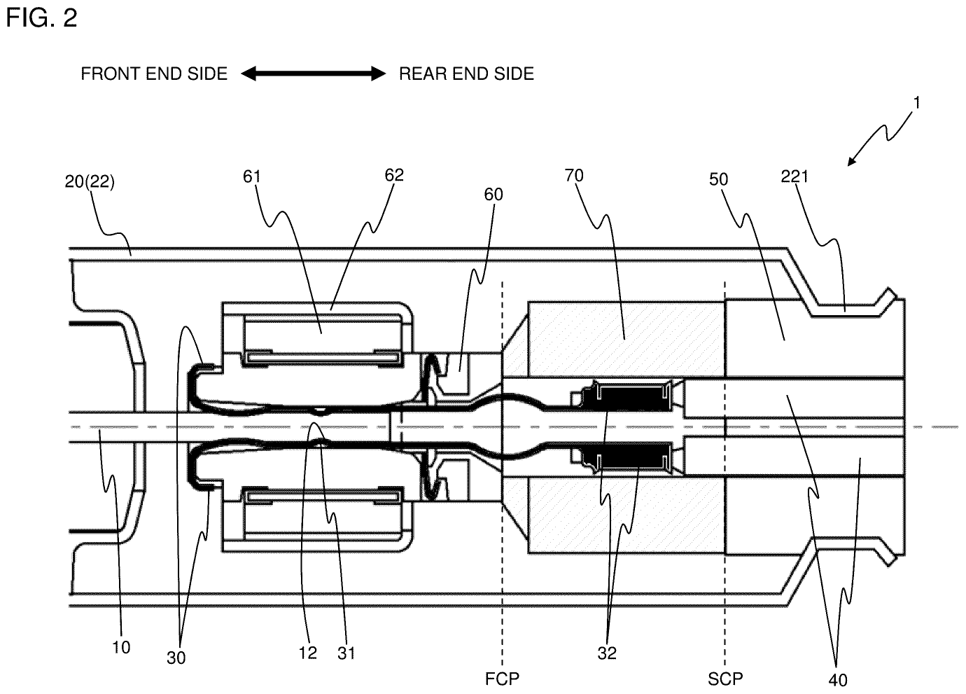

For this reason, in the gas sensor according to one aspect of the present invention, an event such as that “the ceramic housing bites into the spacer arranged on the rear end side of the ceramic housing in a state of being inclined from the axial direction, and such a state is fixed” does not occur. Therefore, the gas sensor according to one aspect of the present invention achieves an effect of being able to prevent the ceramic housing from biting into a member (that is, the spacer) arranged on the rear end side of the ceramic housing in a state of being inclined from the axial direction. The gas sensor according to one aspect of the present invention prevents “the ceramic housing from biting into a member arranged on the rear end side of the ceramic housing in a state of being inclined from the axial direction”, so as to reduce possibility that the terminal fitting breaks when an impact is applied to the gas sensor. Hereinafter, first, a gas sensor 1 will be described as the gas sensor according to one aspect of the present invention with reference to FIGS. 1 and 2.

### [Configuration Example]

### <Overall Outline of Gas Sensor>

FIG. 1 is a schematic cross-sectional view schematically illustrating an example of a main configuration of the gas sensor 1 according to the present embodiment. That is, FIG. 1 schematically illustrates a configuration of a cross section of the gas sensor 1 parallel to and in contact with an axis in a longitudinal direction (axis line, line along a left-right direction in the diagram). The gas sensor 1 is an example of “gas sensor” of the present invention, and is a gas sensor capable of detecting concentration (specific gas concentration) of specific gas such as oxygen or NOₓ in measured gas such as exhaust gas of an automobile. As illustrated in FIG. 1, the gas sensor 1 has an axis and is configured to extend along the longitudinal direction (axial direction), and has a front end and a rear end as ends in the longitudinal direction. One end in the longitudinal direction is a front end, and another end is a rear end. In the example of FIG. 1, the gas sensor 1 is arranged such that a front end of the gas sensor 1 faces a left direction and a rear end of the gas sensor 1 faces a right direction. That is, the left-right direction in FIG. 1 corresponds to the longitudinal direction (axial direction). In the present embodiment, the gas sensor 1 includes a sensor element 10, a tubular body 20 (a main fitting 21, an outer tube 22, and a fixing bolt 23), a terminal fitting 30, a lead wire 40, an elastic body 50, a ceramic housing 60, a spacer 70, and a protective cover 80. In the gas sensor 1, the sensor element 10 is surrounded by the tubular body 20 and the protective cover 80, and the tubular body 20 and the protective cover 80 constitute, as a whole, a housing member (casing) that houses the sensor element 10 in the inside. The sensor element 10 is arranged coaxially with the tubular body 20 and the protective cover 80, and an extending direction of a central axis of the sensor element 10 coincides with an axial direction of the gas sensor 1.

### (Sensor Element)

The sensor element 10 is an example of a “sensor element” of the present invention, and is configured to extend along the axial direction (left-right direction in FIG. 1). The sensor element 10 illustrated in FIG. 1 is an elongated flat plate-like (elongated plate-like) element. The sensor element 10 includes a detection unit 11 on the front end side and a connector electrode (connector electrode 12) on the rear end side. The connector electrode 12 of the sensor element 10 is illustrated in FIG. 2. The front end side of the sensor element 10 exemplified in FIG. 1 is coated with an outer porous layer, and the outer porous layer serves as a protective layer that prevents occurrence of a crack in an element body of the sensor element 10 due to adhesion of moisture or the like in measured gas, for example.

In the gas sensor 1, the sensor element 10 is arranged such that the front end side faces the front end of the gas sensor 1. For example, in one aspect of the sensor element 10, measured gas introduced into the sensor element 10 is reduced or decomposed in the sensor element 10 and an oxygen ion is generated. In the gas sensor 1 including the sensor element 10, concentration of specific gas which is detection target gas in measured gas is obtained based on the fact that an amount of oxygen ions flowing inside the sensor element 10 is proportional to concentration of the specific gas.

In the example illustrated in FIG. 1, the front end side of the sensor element 10 is surrounded by the protective cover 80, the rear end side protrudes into the outer tube 22, and a substantially central portion between the front end side and the rear end side is fixed inside the main fitting 21 by an annular component 90 in such a manner that a space between both end portions is sealed airtightly.

### (Annular Component)

In the example illustrated in FIG. 1, the annular component 90 includes a first ceramic supporter 91, a green compact 92, and a second ceramic supporter 93. The first ceramic supporter 91 and the second ceramic supporter 93 are ceramic insulators. More specifically, a through hole (not illustrated) having a shape corresponding to a cross-sectional shape of the sensor element 10 is provided at an axial center position of the first ceramic supporter 91 and the second ceramic supporter 93, and the sensor element 10 is inserted into the through hole, so that the first ceramic supporter 91 and the second ceramic supporter 93 are annularly mounted on the sensor element 10. Note that the first ceramic supporter 91 is locked to a tapered surface of the main fitting 21 on the left side in the diagram.

On the other hand, the green compact 92 is obtained by molding ceramic powder such as talc. The green compact 92 is obtained, similarly to the first ceramic supporter 91 and the second ceramic supporter 93, as the sensor element 10 is inserted into a through hole, so that two molded bodies (not illustrated) annularly mounted on the sensor element 10 are arranged inside the main fitting 21 in a state of being annularly mounted around the sensor element 10, and then further compressed and integrated. More specifically, ceramic particles constituting the green compact 92 are surrounded by the first ceramic supporter 91, the second ceramic supporter 93, and the main fitting 21, and are densely provided in a space through which the sensor element 10 penetrates inside the main fitting 21. The compressed filling with the green compact 92 achieves airtight sealing between the front end side and the rear end side of the sensor element 10.

FIG. 1 illustrates an example in which the annular component 90 includes the first ceramic supporter 91, the green compact 92, and the second ceramic supporter 93. However, in the gas sensor 1, it is not essential that the annular component 90 be composed of the first ceramic supporter 91, the green compact 92, and the second ceramic supporter 93. The gas sensor 1 exemplified in FIG. 1 includes the annular component 90 that fixes the sensor element 10 inside the main fitting 21 and airtightly seals a space between the front end side and the rear end side of the sensor element 10.

### (Tubular Body)

The tubular body 20 is an example of “tubular body” of the present invention. The tubular body 20 is, for example, a tubular (for example, a cylindrical) member made from metal, and has an opening end. The sensor element 10 is arranged inside the tubular body 20. In the example illustrated in FIG. 1, the tubular body 20 includes the tubular main fitting 21, the tubular outer tube 22, and the fixing bolt 23, each of which is a metal member.

The main fitting 21 is a tubular (for example, cylindrical) member made from metal. Inside the main fitting 21, the sensor element 10 and the annular component 90 for fixing, which is annularly mounted on the sensor element 10, are housed. That is, the main fitting 21 is further annularly mounted on the annular component 90 annularly mounted around the sensor element 10. The main fitting 21 illustrated in FIG. 1 is configured to surround the sensor element 10 along the axial direction (longitudinal direction), and is particularly configured to surround a range excluding a part of each of the front end side and the rear end side of the sensor element 10.

The outer tube 22 is a cylindrical (for example, cylindrical) member made from metal, and the outer tube 22 illustrated in FIG. 1 covers the rear end of the sensor element 10, the ceramic housing 60 (terminal fitting 30), and a periphery of the spacer 70.

An end portion (opening end) on the front end side of the outer tube 22 is welded and fixed to an outer peripheral end portion on the rear end side of the main fitting 21. Further, the elastic body 50 is arranged at an opening end on the rear end side of the outer tube 22 so as to seal the opening end. On the rear end side of the outer tube 22, a reduced diameter portion 221 for swaging a part of the elastic body 50 for sealing an opening end on the rear end side from a periphery is formed. In the reduced diameter portion 221, the outer tube 22 is swaged from the outer side in a diameter reducing manner over the entire circumferential direction of the outer tube 22, so that reaction force directed to the outer side in a radial direction is generated in the elastic body 50, so that the outer tube 22 is sealed.

Further, the lead wire 40 is drawn out from an opening end on the rear end side of the outer tube 22 sealed by the elastic body 50 to the outside through a through hole (not illustrated) formed inside the elastic body 50. Outside air (atmosphere) is introduced into an internal space of the outer tube 22 through between coating of the lead wire 40 and a metal wire (conductor) (in other words, the inner side of the coating), and the internal space of the outer tube 22 has reference gas (air) atmosphere. A rear end of the sensor element 10 is arranged in the internal space of the outer tube 22 filled with reference gas.

The fixing bolt 23 is an annular member used to fix the gas sensor 1 to a measurement position (attachment position), and is fixed coaxially with the main fitting 21. The fixing bolt 23 includes a threaded bolt portion and a holding portion held when the bolt portion is screwed. The bolt portion of the fixing bolt 23 is screwed with a nut provided at an attachment position of the gas sensor 1. For example, when the bolt portion of the fixing bolt 23 is screwed into a nut (nut portion) provided in an exhaust pipe of an automobile, the gas sensor 1 is fixed to the exhaust pipe in a mode in which the protective cover 80 side is exposed to the inside of the exhaust pipe.

As described above, the tubular body 20 illustrated in FIG. 1 includes the main fitting 21, the outer tube 22, and the fixing bolt 23, and is configured as a tubular (for example, cylindrical) member as a whole, particularly as a tubular member extending in the axial direction. That is, the tubular body 20 exemplified in FIG. 1 is a cylindrical member extending in the axial direction, including the tubular main fitting 21, the tubular outer tube 22 welded and fixed to an outer peripheral end portion on the rear end side of the main fitting 21, and the fixing bolt 23 arranged on an outer periphery on the front end side of the main fitting 21. For example, the tubular body 20 and the gas sensor 1 (sensor element 10) are coaxial, and the tubular body 20 has a front end and a rear end as ends in the axial direction (longitudinal direction), and is arranged such that the front end of the tubular body 20 faces the front end of the gas sensor 1. Then, in the inside of the tubular body 20, the sensor element 10, the annular component 90 for fixing annularly mounted on the sensor element 10, the ceramic housing 60 (terminal fitting 30), and the spacer 70, and an opening end on the rear end side is sealed by the elastic body 50. The reduced diameter portion 221 for fixing the elastic body 50 for sealing an opening end of the tubular body 20 is formed on the rear end side of the tubular body 20 (outer tube 22), and the reduced diameter portion 221 swages a part of the elastic body 50 from a periphery.

Note that, in the gas sensor 1, it is not essential that the tubular body 20 include the main fitting 21, the outer tube 22, and the fixing bolt 23. The tubular body 20 does not need to include the fixing bolt 23, or the main fitting 21 and the outer tube 22 may be integrally formed. In the gas sensor 1, the tubular body 20 only needs to be a tubular member in which the sensor element 10 is arranged and an opening end is formed.

### (Terminal Fitting)

The terminal fitting 30 is an example of “terminal fitting” of the present invention. The terminal fitting 30 is a metal member (contact member) extending in the axial direction. In the gas sensor 1, the sensor element 10 (in particular, the connector electrode 12 of the sensor element 10) and the lead wire 40 are electrically connected via the terminal fitting 30. Although described in detail in FIG. 2, the terminal fitting 30 has an element contact portion 31 electrically connected to the connector electrode 12 of the sensor element 10 on the front end side, and has a lead wire holding portion 32 that crimps and holds the lead wire 40 on the rear end side.

### (Ceramic Housing)

The ceramic housing 60 is an example of “ceramic housing” of the present invention. The ceramic housing 60 is a ceramic member that houses the rear end side of the sensor element 10 (specifically, the connector electrode 12 provided on the rear end side of the sensor element 10) and the front end side of the terminal fitting 30 (specifically, the element contact portion 31 described with reference to FIG. 2). That is, in the gas sensor 1 exemplified in FIG. 1, the sensor element 10 (in particular, the connector electrode 12) and the terminal fitting 30 (in particular, the element contact portion 31) are electrically connected in the ceramic housing 60.

For example, the rear end side of the sensor element 10 provided with the connector electrode 12 is inserted into the ceramic housing 60 housing the front end side (element contact portion 31) of the terminal fitting 30. In this insertion state, the connector electrode 12 provided on the rear end side of the sensor element 10 and the front end side (element contact portion 31) of the terminal fitting 30 are in contact with each other. The front end side (element contact portion 31) of the terminal fitting 30 may be sandwiched and fixed between the rear end side of the sensor element 10 provided with the connector electrode 12 and the ceramic housing 60, so that the connector electrode 12 of the sensor element 10 and the terminal fitting 30 are electrically connected.

In the gas sensor 1, there is a gap between the ceramic housing 60 and the tubular body 20 (outer tube 22), that is, the ceramic housing 60 is not in contact with the tubular body 20. A position of the ceramic housing 60 inside the tubular body 20 may be fixed without being in contact with the tubular body 20 by being integrated with the sensor element 10. As exemplified in FIG. 1, a position of the sensor element 10 inside the tubular body 20 is fixed by the annular component 90 and the tubular body 20 (in particular, the main fitting 21 and the outer tube 22). A position of the ceramic housing 60 inside the tubular body 20 may be fixed without being in contact with the tubular body 20 by being integrated with the sensor element 10 whose position inside the tubular body 20 is fixed by the annular component 90 and the tubular body 20.

The ceramic housing 60 (more precisely, a contact member in which the ceramic housing 60, the spacer 70, and the elastic body 50 are arranged in this order from the front end side in the axial direction) may be integrated with the sensor element 10 as described below. That is, after the lead wire holding portion 32 of the terminal fitting 30 is connected to a front end of the lead wire 40 inserted through the elastic body 50 and the spacer 70, the ceramic housing 60 provided with an insertion port on the front end side in the axial direction is assembled to the terminal fitting 30. More precisely, the ceramic housing 60 in which a fixing fitting provided with a pressing spring 61 (see FIG. 2) and a swaging ring 62 (see FIG. 2) are not assembled yet is assembled to the terminal fitting 30 in which a front end of the lead wire 40 is connected to the lead wire holding portion 32. After the above, a fixing fitting including the pressing spring 61 and the swaging ring 62 are further assembled to an outer periphery of the ceramic housing 60 to prepare a contact member (preliminary assembly). The pressing spring 61 is, for example, a leaf spring member having a trapezoidal shape in a cross-sectional view without an upper base portion, and generates elastic force as restoring force when external force acts on a free end portion of the pressing spring 61. When the sensor element 10 and the above-described contact member are integrated, the swaging ring 62 is swaged in a state where the sensor element 10 (in particular a rear end portion of the sensor element 10) is inserted into an insertion port of the ceramic housing 60, that is, the swaging ring 62 is deformed to be reduced in size by external force. By the above, a space of the insertion port of the ceramic housing 60 is narrowed, and the sensor element 10 and the ceramic housing 60 (contact member) are integrated. At this time, the element contact portion 31 of the terminal fitting 30 comes into contact with the connector electrode 12 of the sensor element 10. For this reason, in the gas sensor 1, electrical conduction between the sensor element 10 and the outside is achieved via the lead wire 40 connected to the terminal fitting 30 and a contact member (terminal fitting 30) connected to the lead wire 40.

### (Lead Wire)

The lead wire 40 is electrically connected to the connector electrode 12 of the sensor element 10 via the terminal fitting 30, and extends outward from an opening end of the tubular body 20. Specifically, the lead wire 40 is electrically connected to the rear end side (specifically, the lead wire holding portion 32 described with reference to FIG. 2) of the terminal fitting 30 on the front end side of the lead wire 40, and the rear end side of the lead wire 40 extends outward from an opening end of the tubular body 20. Then, as described above, a gap between the lead wire 40 and the tubular body 20 (outer tube 22) is sealed by the elastic body 50.

For example, the lead wire 40 is inserted into a through hole (not illustrated) continuously provided in the elastic body 50 and the spacer 70. An end portion on the front end side of the lead wire 40 is crimped and fixed to the rear end side (lead wire holding portion 32) of the terminal fitting 30, and an end portion on the rear end side of the lead wire 40 is connected to an external device (controller), a power supply, or the like. By the above, the sensor element 10 (in particular, the connector electrode 12 of the sensor element 10) is electrically connected to an external device, a power supply, and the like through the terminal fitting 30 and the lead wire 40. Note that, although FIG. 1 illustrates an example in which there are two of the terminal fittings 30 and two of the lead wires 40, this is merely for the sake of simplicity of illustration. In practice, the gas sensor 1 includes the terminal fittings 30 and the lead wires 40 as many as necessary for the above-described electrical connection.

### (Elastic Body)

The elastic body 50 is an example of “elastic body” of the present invention. The elastic body 50 is a member having elasticity, and is made from, for example, rubber. The elastic body 50 is arranged so as to seal an opening end (in the example illustrated in FIG. 1, an opening end on the rear end side) of the tubular body 20, and the lead wire 40 is inserted into the elastic body 50. Specifically, in the inside of the elastic body 50, a through hole extending in the axial direction is formed, and for example, a plurality of through holes extending in the axial direction is formed. The lead wire 40 is housed (inserted) in a through hole formed inside the elastic body 50, and for example, each of a plurality of the lead wires 40 is housed (inserted) in each of a plurality of through holes formed inside the elastic body 50.

A material of the elastic body 50 is, for example, fluororubber. Fluororubber has an excellent characteristic in various aspects such as resistance and strength, and is particularly excellent in heat resistance and oil resistance. For this reason, the gas sensor 1 uses the elastic body 50 made from fluororubber, so that, for example, sealing property of the elastic body 50 can be secured under a high-temperature environment, and an effect that detection accuracy of gas concentration can be maintained and improved is achieved. However, it is not essential for the gas sensor 1 to use fluororubber as a material of the elastic body 50, and, in the gas sensor 1, a material having elasticity may be appropriately used as a material of the elastic body 50.

### (Spacer)

The spacer 70 is an example of “spacer” of the present invention. The spacer 70 is arranged between the ceramic housing 60 and the elastic body 50 in the axial direction of the gas sensor 1 (sensor element 10), and specifically, is arranged further on the rear end side than the ceramic housing 60 and further on the front end side of the elastic body 50. The spacer 70 is in contact with the ceramic housing 60 (in particular, a rear end surface of the ceramic housing 60) on a front end surface of the spacer 70, and is in contact with the elastic body 50 (in particular, a front end surface of the elastic body 50) on a rear end surface of the spacer 70. For example, a position of the spacer 70 inside the tubular body 20 (outer tube 22) is fixed by the ceramic housing 60 and the elastic body 50. That is, the spacer 70 is sandwiched (interposed) between the ceramic housing 60 and the elastic body 50 inside the tubular body 20. That is, a front end surface of the spacer 70 is in contact with a rear end surface of the ceramic housing 60, and as described above, the ceramic housing 60 is integrated with the sensor element 10 so that the position inside the tubular body 20 is fixed. Further, a rear end surface of the spacer 70 is in contact with a front end surface of the elastic body 50, and as described above, the elastic body 50 is fixed to an opening end (in the example illustrated in FIG. 1, an opening end on the rear end side) of the tubular body 20 by the reduced diameter portion 221. For this reason, a position of the spacer 70 inside the tubular body 20 (outer tube 22) is fixed by the ceramic housing 60 and the elastic body 50.

The lead wire 40 is inserted into the spacer 70 exemplified in FIG. 1. For example, in the example illustrated in FIG. 1, the lead wire 40 and the terminal fitting 30 (in particular, a rear end of the terminal fitting 30 electrically connected to the lead wire 40) are housed inside the spacer 70.

The spacer 70 is made from, for example, a heat-resistant material. When the spacer 70 is made from a heat-resistant material, it is possible to prevent occurrence of an event in which the spacer 70 arranged further on the front end side than the elastic body 50 in the axial direction is eroded by heat generated from a heat source on the front end side of the gas sensor 1. For example, by interposing the spacer 70 between the elastic body 50 and the ceramic housing 60, it is possible to prevent excessive temperature rise of the elastic body 50 at the time of use of the gas sensor 1 or the like. That is, from the viewpoint of preventing heat transfer to the elastic body 50, thermal conductivity of the spacer 70 is desirably low. However, while temperature rise of the elastic body 50 is reduced by the spacer 70, temperature of the spacer 70 becomes high, and the spacer 70 itself needs to have sufficient heat resistance. In view of the above, by constituting the spacer 70 with a heat resistant material, it is possible to prevent occurrence of an event in which the spacer 70 itself is eroded by heat generated from a heat source while preventing heat transfer from the heat source to the elastic body 50.

Specifically, in the gas sensor 1, the spacer 70 is made from ceramics. Ceramics have excellent heat resistance and generally have a higher melting point than resin. Then, in the gas sensor 1, the spacer 70 is arranged further on the front end side in the axial direction than the elastic body 50. When the spacer 70 is made from ceramics having excellent heat resistance, the gas sensor 1 achieves an effect below. That is, the gas sensor 1 achieves an effect of being able to prevent occurrence of an event in which the spacer 70 is eroded by heat generated from a heat source on the front end side of the gas sensor 1. However, it is not essential for the gas sensor 1 that the spacer 70 be made from ceramics, and, in the gas sensor 1, a material having heat resistance may be appropriately used as a material of the spacer 70.

In the spacer 70, at least Young's modulus of a front end portion including a front end surface is 80 GPa or more. In the gas sensor 1, Young's modulus of the entire spacer 70 is 80 GPa or more, that is, Young's modulus of not only a front end portion but also the entire spacer 70 is 80 GPa or more.

In the gas sensor 1, the spacer 70 is arranged between the ceramic housing 60 and the elastic body 50. In the gas sensor 1, the ceramic housing 60 (in particular, a rear end surface of the ceramic housing 60) is in contact with not the elastic body 50 but the spacer 70 arranged on the rear end side of the ceramic housing 60, particularly a front end surface of the spacer 70. For this reason, the gas sensor 1 can prevent the ceramic housing 60 from biting into the elastic body 50 in a state of being inclined from the axial direction.

In particular, in the gas sensor 1, the ceramic housing 60 is in contact with the spacer 70 arranged on the rear end side of the ceramic housing 60, particularly, a front end surface of the spacer 70. Then, Young's modulus of a front end portion including a front end surface of the spacer 70 is 80 GPa or more, that is, a front end portion of the spacer 70 has sufficient hardness that can significantly prevent the ceramic housing 60 from biting into the spacer 70 (in particular, the front end portion of the spacer 70).

For this reason, in the gas sensor 1, an event such as that “the ceramic housing 60 bites into the spacer 70 arranged on the rear end side of the ceramic housing 60 in a state of being inclined from the axial direction, and such a state is fixed” does not occur. Therefore, the gas sensor 1 achieves an effect of being able to prevent the ceramic housing 60 from biting into a member (that is, the spacer 70) arranged on the rear end side of the ceramic housing 60 in a state of being inclined from the axial direction. The gas sensor 1 prevents “the ceramic housing 60 from biting into a member arranged on the rear end side of the ceramic housing 60 in a state of being inclined from the axial direction”, so as to reduce possibility that the terminal fitting 30 breaks when an impact is applied to the gas sensor 1.

### (Protective Cover)

The protective cover 80 is a substantially cylindrical exterior member that protects a predetermined range on the front end side, which is a portion of the sensor element 10 that directly contacts measured gas at the time of use. The protective cover 80 illustrated in FIG. 1 is configured to surround at least a part of the front end side of the tubular body 20 (main fitting 21) along the axial direction (longitudinal direction) and extend beyond a front end of the sensor element 10. For example, the protective cover 80 is configured to surround a part of the front end side of the tubular body 20 and the sensor element 10 around the axis. The protective cover 80 has a front end and a rear end as ends in the axial direction, and the front end of the protective cover 80 is arranged further on the front end side of the gas sensor 1 than the front end of the sensor element 10.

The protective cover 80 is provided with a plurality of through holes (not illustrated) through which gas can pass. Measured gas flowing into the protective cover 80 through the through hole is a direct detection target in the sensor element 10. Note that a type, the number, an arrangement position, a shape, and the like of through-holes provided in the protective cover 80 may be appropriately determined in consideration of an inflow mode of measured gas into the protective cover 80.

In the example illustrated in FIG. 1, the protective cover 80 includes a bottomed tubular inner cover 81 that covers a front end of the sensor element 10 and a bottomed tubular outer cover 82 that covers the inner cover 81. The inner cover 81 includes a first member 81B and a second member 81A, and is configured to cover a periphery of at least a part of the front end side of the sensor element 10 and the tubular body 20 (main fitting 21). The first member 81B extends along the axial direction from an outer wall of a front end portion of the tubular body 20, and is configured to further extend along the axial direction after a diameter decreases in a direction perpendicular to the axial direction around a portion beyond a front end of the tubular body 20. The second member 81A is configured to cover a periphery of a part of the front end side of the first member 81B. The outer cover 82 is configured to cover a periphery of the inner cover 81.

A sensor element chamber is formed as a space surrounded by the inner cover 81, and a front end of the sensor element 10 is arranged in the sensor element chamber. An opening is appropriately provided in the first member 81B and the second member 81A of the inner cover 81 and the outer cover 82, so that the sensor element chamber is connected to a space outside the protective cover 80. However, a configuration and shape of the protective cover 80 are not limited to such an example. A configuration and shape of the protective cover 80 may be appropriately determined according to an embodiment.

As a material of the protective cover 80, for example, a metal material such as stainless steel (for example, SUS) may be used. The protective cover 80 may be manufactured by appropriately molding a metal material. Note that the protective cover 80 may be omitted from a configuration of the gas sensor 1.

### <Details of Rear End Side of Gas Sensor>

FIG. 2 is an enlarged cross-sectional view schematically illustrating a main part of the gas sensor 1, specifically, a cross-sectional view illustrating the rear end side of the gas sensor in an enlarged manner. In FIG. 2, the left-right direction in the diagram is the axial direction (longitudinal direction) of the gas sensor 1 (sensor element 10), and the left side in the diagram is the front end side and the right side in the diagram is the rear end side.

As illustrated in detail in FIG. 2, the ceramic housing 60, the spacer 70, and the elastic body 50 are arranged in this order from the front end side to the rear end side on the rear end side of the gas sensor 1. A rear end surface of the ceramic housing 60 is in contact with a front end surface of the spacer 70, and a rear end surface of the spacer 70 is in contact with a front end surface of the elastic body 50. As described above, in the gas sensor 1, Young's modulus of the entire spacer 70 is 80 GPa or more. For this reason, in the gas sensor 1, Young's modulus of a front end portion of the spacer 70 is 80 GPa or more, that is, the ceramic housing 60 (in particular, a rear end surface of the ceramic housing 60) is in contact with the spacer 70 (in particular, a front end surface of the spacer 70) having Young's modulus of 80 GPa or more.

Here, the gas sensor 1 illustrated in FIGS. 1 and 2 is manufactured through, for example, a process below. That is, first, a contact member in which the ceramic housing 60 to which the terminal fitting 30 is attached, the spacer 70, and the elastic body 50 are arranged in this order from the front end side in the axial direction is prepared (preliminary assembly). At a time point of the preliminary assembly, a fixing fitting including the pressing spring 61 and the swaging ring 62 illustrated in FIG. 2 do not need to be assembled to an outer periphery of the ceramic housing 60 yet. As described above, the pressing spring 61 is, for example, a leaf spring member, and the swaging ring 62 is deformed to be reduced in size by external force to integrate the sensor element 10 and the ceramic housing 60 (contact member). After the preliminary assembly is completed, the rear end side of the sensor element 10 is then inserted into the ceramic housing 60 (in particular, an insertion port provided on the front end side of the ceramic housing 60) to which the terminal fitting 30 is attached. Then, the sensor element 10 and the ceramic housing 60 (contact member) are integrated by swaging the swaging ring 62 provided to fix the ceramic housing 60 into which the sensor element 10 is inserted from an outer periphery.

The gas sensor 1 is manufactured through, for example, a process below in addition to the above-described preliminary assembly process. That is, the gas sensor 1 is manufactured through a swaging process of swaging the elastic body 50 arranged at an opening end of the tubular body 20 (outer tube 22) and the tubular body 20 in a diameter reducing manner to fix the elastic body 50 to an opening end of the tubular body 20 and seal the opening end with the elastic body 50.

### (Regarding Mode of Contact Between Ceramic Housing and Spacer)

As exemplified in FIG. 2, in the gas sensor 1, the contact area A1 between the spacer 70 (in particular, a front end surface of the spacer 70) and the ceramic housing 60 (in particular, a rear end surface of the ceramic housing 60) is adjusted to be sufficiently large. Specifically, in the gas sensor 1, the contact area A1 is 3 mm² or more. However, in the gas sensor 1, it is not essential to set the contact area A1 to 3 mm² or more, and the contact area A1 may be less than 3 mm².

The present inventors have considered that it is effective to sufficiently secure the contact area A1 between the spacer 70 and the ceramic housing 60 in order to prevent the ceramic housing 60 from being fixed in a state of being inclined from the axial direction. For example, it is considered that when the contact area A1 is small, force is likely to act in a direction inclined from the axial direction from the spacer 70 to the ceramic housing 60 as compared with a case where the contact area A1 is large, and as a result, the ceramic housing 60 is likely to be inclined from the axial direction. Further, it is considered that when the contact area A1 is small, contact between the spacer 70 and the ceramic housing 60 is not stable as compared with a case where the contact area A1 is large, and as a result, the ceramic housing 60 is likely to be inclined from the axial direction, for example, in a case where an impact is applied to the gas sensor 1. In view of the above, the present inventors have verified a range of the contact area A1 between the spacer 70 and the ceramic housing 60 effective for preventing the ceramic housing 60 from being fixed in a state of being inclined from the axial direction. As a result, the present inventors have confirmed that by setting the contact area A1 to 3 mm² or more, it is possible to remarkably prevent the ceramic housing 60 from being fixed in a state of being inclined from the axial direction as compared with a case of setting the contact area A1 to less than 3 mm².

In the gas sensor 1, the contact area A1 between the spacer 70 and the ceramic housing 60 is 3 mm² or more. Therefore, the gas sensor 1 achieves an effect of being able to remarkably prevent the ceramic housing 60 from being fixed in a state of being inclined from the axial direction as compared with a case where the contact area A1 between the spacer 70 and the ceramic housing 60 is less than 3 mm².

Here, as described above, the gas sensor 1 is manufactured through, for example, the preliminary assembly process. Then, if the ceramic housing 60 is inclined from the axial direction at a time point of the preliminary assembly, the ceramic housing 60 is integrated with the sensor element 10 in the inclined state, that is, the state in which the ceramic housing 60 is inclined from the axial direction is fixed.

In view of the above, for example, by sufficiently securing the contact area A1 between the spacer 70 and the ceramic housing 60 at a time point of the preliminary assembly, it is possible to prevent the ceramic housing 60 from being positioned in a state of being inclined from the axial direction in the contact member described above. Specifically, by setting the contact area A1 to 3 mm² or more at a time point of the preliminary assembly, the gas sensor 1 can prevent occurrence of an event in which “the ceramic housing 60 is positioned in a state of being inclined from the axial direction at a time point of the preliminary assembly”.

As exemplified in FIG. 2, in the gas sensor 1, the spacer 70 and the ceramic housing 60 are in contact with each other on a straight line obtained by axially extending the axis of the sensor element 10 (gas sensor 1) (that is, an extension line of the axis). For example, in the gas sensor 1, the distance L1 from a position of the center of gravity CG1 of a “portion of the spacer 70 (in particular, a front end surface of the spacer 70) in contact with the ceramic housing 60 (in particular, a rear end surface of the ceramic housing 60)” to the extension line of the axis of the sensor element 10 is within 2 mm. The center of gravity CG1 is the center of mass when mass is virtually uniformly distributed in a portion in contact with the ceramic housing 60 (in particular, a rear end surface of the ceramic housing 60) on a front end surface of the spacer 70. Note that, in the gas sensor 1, it is not essential to set the distance L1 within 2 mm, and the distance L1 may be larger than 2 mm.

The present inventors have considered that it is effective to bring the spacer 70 and the ceramic housing 60 into contact with each other on the extension line of the axis of the sensor element 10 (gas sensor 1) in order to prevent the ceramic housing 60 from being fixed in a state of being inclined from the axial direction. In particular, the present inventors have considered that, if the distance L1 from the center of gravity CG1 of a contact surface between the spacer 70 and the ceramic housing 60 to the extension line of the axis can be sufficiently reduced, the ceramic housing 60 can be effectively prevented from being fixed in a state of being inclined from the axial direction. In view of the above, the present inventors have verified the distance L1 from the center of gravity CG1 to the extension line of the axis, which is effective for preventing the ceramic housing 60 from being fixed in a state of being inclined from the axial direction. As a result, the present inventors have confirmed that by setting the distance L1 from the center of gravity CG1 to the extension line of the axis to be within 2 mm, it is possible to remarkably prevent the ceramic housing 60 from being fixed in a state of being inclined from the axial direction as compared with a case where the distance L1 is set to be larger than 2 mm.

In the gas sensor 1, the distance L1 from a position of the center of gravity CG1 of a portion of the spacer 70 in contact with the ceramic housing 60 to the extension line of the axis of the sensor element 10 (gas sensor 1) is within 2 mm.

Therefore, the gas sensor 1 achieves an effect of being able to remarkably prevent the ceramic housing 60 from being fixed in a state of being inclined from the axial direction as compared with a case where the distance L1 from the center of gravity CG1 to the extension line of the axis is larger than 2 mm.

Here, as described above, the gas sensor 1 is manufactured through, for example, the preliminary assembly process. However, if the ceramic housing 60 is inclined from the axial direction at a time point of the preliminary assembly, the ceramic housing 60 is integrated with the sensor element 10 in the inclined state, that is, the state in which the ceramic housing 60 is inclined from the axial direction is fixed.

In view of the above, for example, by bringing the spacer 70 and the ceramic housing 60 into contact with each other on the extension line of the axis at a time point of the preliminary assembly, it is possible to prevent the ceramic housing 60 from being positioned in a state of being inclined from the axial direction in the contact member. Specifically, at a time point of the preliminary assembly, the distance L1 from the center of gravity CG1 of a contact surface between the spacer 70 and the ceramic housing 60 to the extension line of the axis is set to be within 2 mm. By the above, the gas sensor 1 can prevent occurrence of an event in which “the ceramic housing 60 is positioned in a state of being inclined from the axial direction at a time point of the preliminary assembly”.

Note that, in the gas sensor 1 illustrated in FIGS. 1 and 2, a front end surface of the spacer 70 and a rear end surface of the ceramic housing 60 are similar in area and shape, that is, they are substantially equal in area and shape.

By making a front end surface of the spacer 70 and a rear end surface of the ceramic housing 60 substantially equal (similar) in area and shape, the gas sensor 1 achieves an effect below. That is, in a case where a front end surface of the spacer 70 and a rear end surface of the ceramic housing 60 are similar to each other, it is easy to bring the front end surface and the rear end surface into contact with each other on the extension line of the axis of the sensor element 10, for example, in a manufacturing stage of the gas sensor 1 and the like, as compared with a case where the front end surface and the rear end surface are different from each other. In particular, by making a front end surface of the spacer 70 and a rear end surface of the ceramic housing 60 similar to each other, it is easy to reduce the distance L1 from the center of gravity CG1 of a contact portion between the front end surface and the rear end surface to the extension line of the axis of the sensor element 10 (for example, to be within 2 mm) in the manufacturing stage or the like. Here, that a front end surface of the spacer 70 and a rear end surface of the ceramic housing 60 are “similar” means that, for example, the front end surface and the rear end surface are circular or elliptical, and a difference in area between them is about 40% or less of an area of at least one of them.

However, in the gas sensor 1, it is not essential to make a front end surface of the spacer 70 similar to a rear end surface of the ceramic housing 60, and for example, it is not essential to make the front end surface of the spacer 70 and the rear end surface of the ceramic housing 60 substantially equal in area and shape. In the gas sensor according to one aspect of the present invention, a front end surface of the spacer and a rear end surface of the ceramic housing may be similar to or different from each other.

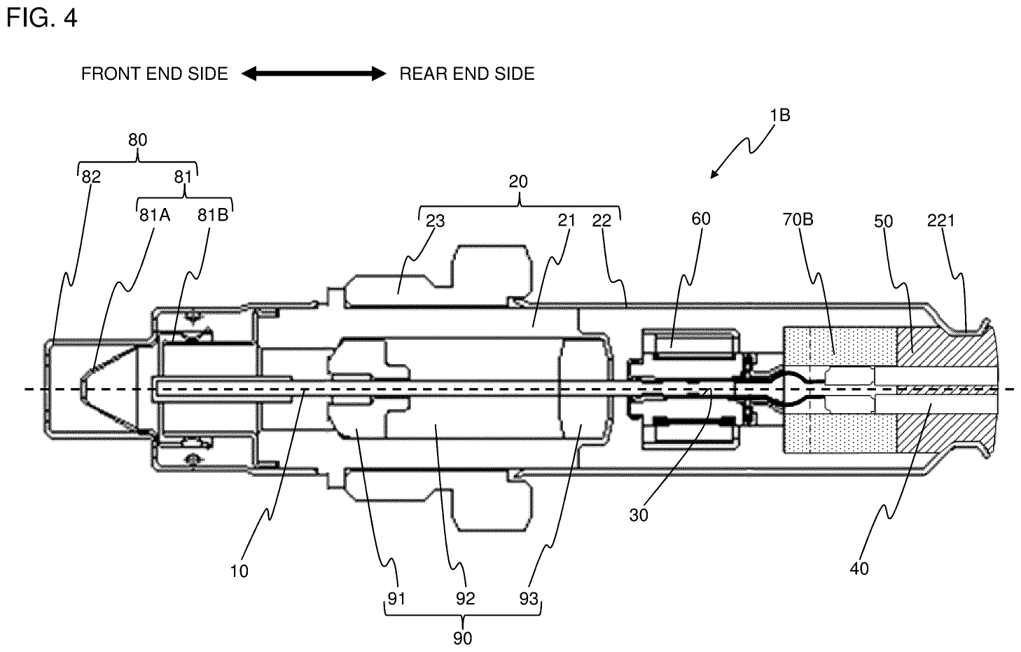

For example, in the gas sensor 1, a front end surface of the spacer 70 may be smaller than a rear end surface of the ceramic housing 60. Similarly, in the gas sensor 1, a front end surface of the spacer 70 may be larger than a rear end surface of the ceramic housing 60. By making a front end surface of the spacer 70 larger than a rear end surface of the ceramic housing 60, the gas sensor 1 achieves an effect below. That is, in a case where a front end surface of the spacer 70 is larger than a rear end surface of the ceramic housing 60, it is easy to sufficiently secure the contact area A1 between them, for example, in a manufacturing stage of the gas sensor 1 as compared with a case where the front end surface is smaller than the rear end surface, and specifically, it is easy to set the contact area A1 to 3 mm². As the gas sensor according to one aspect of the present invention, an example in which a front end surface of the spacer in contact with the ceramic housing (in particular, a rear end surface of the ceramic housing) is made larger than a rear end surface of the ceramic housing will be described later with reference to FIG. 4.

(Regarding Mode of Contact Between Spacer and elastic body)

As exemplified in FIG. 2, in the gas sensor 1, the contact area A2 between the spacer 70 (in particular, a rear end surface of the spacer 70) and the elastic body 50 (in particular, a front end surface of the elastic body 50) is adjusted to be sufficiently large. Specifically, in the gas sensor 1, the contact area A2 is 25% or more of an entire area of a front end surface of the elastic body 50. However, in the gas sensor 1, it is not essential to set the contact area A2 to 25% or more of an entire area of a front end surface of the elastic body 50, and the contact area A2 may be less than 25% of an entire area of a front end surface of the elastic body 50.

The present inventors have considered that it is effective to sufficiently secure the contact area A2 between the spacer 70 and the elastic body 50 in order to prevent the ceramic housing 60 from being fixed in a state of being inclined from the axial direction. For example, it is considered that when the contact area A2 is small, force is likely to act in a direction inclined from the axial direction from the elastic body 50 to the spacer 70 as compared with a case where the contact area A2 is large, and as a result, the ceramic housing 60 in contact with the spacer 70 is also likely to be inclined from the axial direction. Further, when the contact area A2 is small, contact between the elastic body 50 and the spacer 70 is not stable as compared with a case where the contact area A2 is large, and it is considered that the spacer 70 (in particular, an end surface of the spacer 70) is likely to be inclined from the axial direction, for example, in a case where an impact is applied to the gas sensor 1 and the like. Then, it is considered that as the spacer 70 (in particular, an end surface of the spacer 70) is inclined from the axial direction, the ceramic housing 60 in contact with the spacer 70 (in particular, an end surface on the front end side of the spacer 70) is also likely to be inclined from the axial direction. In view of the above, the present inventors have verified a range of the contact area A2 between the spacer 70 and the elastic body 50 effective for preventing the ceramic housing 60 from being fixed in a state of being inclined from the axial direction. The present inventors have confirmed that by setting the contact area A2 to 25% or more of an entire area of a front end surface of the elastic body 50, it is possible to remarkably prevent the ceramic housing 60 from being fixed in a state of being inclined from the axial direction, as compared with a case where the contact area A2 is set to less than 25%.

In the gas sensor 1, an area of a portion in contact with the spacer 70 of a front end surface of the elastic body 50, that is, the above-described contact area A2 is 25% or more of an entire area of the front end surface of the elastic body 50.

Therefore, the gas sensor 1 achieves an effect of being able to remarkably prevent the ceramic housing 60 from being fixed in a state of being inclined from the axial direction as compared with a case where the contact area A2 is less than 25% of an entire area of a front end surface of the elastic body 50.

Here, as described above, the gas sensor 1 is manufactured through, for example, a swaging process. In this swaging process, there is a possibility that the elastic body 50 is deformed and stress acts on the spacer 70 in a direction inclined from the axial direction. For example, in the swaging process, there is a possibility that a front end surface of the elastic body 50 is pushed out to the front end side in the axial direction in a state of being inclined from the axial direction, and applies stress in a direction inclined from the axial direction to the spacer 70. When the contact area A2 between the spacer 70 and the elastic body 50 is small at a time point of the swaging process, the spacer 70 is not stabilized since the elastic body 50 is soft, and stress acts in a direction inclined from the axial direction on the spacer 70 from the elastic body 50, and the spacer 70 is likely to be inclined from the axial direction. Then, as the spacer 70 (in particular, a front end surface of the spacer 70) is inclined from the axial direction, there is a possibility that the ceramic housing 60 in contact with the spacer 70 is also inclined from the axial direction.

In view of the above, for example, by sufficiently securing the contact area A2 between the spacer 70 and the elastic body 50 in the above-described swaging process, the gas sensor 1 can prevent the ceramic housing 60 from being inclined from the axial direction. Specifically, by setting the contact area A2 to 25% or more of an entire area of a front end surface of the elastic body 50 in the swaging process, the gas sensor 1 can prevent occurrence of an event in which “the ceramic housing 60 is inclined from the axial direction in the swaging process”.

As exemplified in FIG. 2, in the gas sensor 1, the elastic body 50 and the spacer 70 are in contact with each other on a straight line obtained by axially extending the axis of the sensor element 10 (gas sensor 1) (that is, an extension line of the axis). In particular, in the gas sensor 1, the distance L2 from a position of the center of gravity CG2 of a “portion of the elastic body 50 (in particular, a front end surface of the elastic body 50) in contact with the spacer 70 (in particular, a rear end surface of the spacer 70)” to the extension line of the axis of the sensor element 10 is within 2 mm. The center of gravity CG2 is the center of mass when mass is virtually uniformly distributed in a portion in contact with the spacer 70 (in particular, a rear end surface of the spacer 70) on a front end surface of the elastic body 50. Note that, in the gas sensor 1, it is not essential to set the distance L2 to be within 2 mm, and the distance L2 may be larger than 2 mm.

The present inventors have considered that it is effective to bring the elastic body 50 and the spacer 70 into contact with each other on the extension line of the axis of the sensor element 10 (gas sensor 1) in order to prevent the ceramic housing 60 from being fixed in a state of being inclined from the axial direction. In particular, the present inventors have considered that, if the distance L2 from the center of gravity CG2 of a contact surface between the elastic body 50 and the spacer 70 to the extension line of the axis can be sufficiently reduced, the ceramic housing 60 can be effectively prevented from being fixed in a state of being inclined from the axial direction. In view of the above, the present inventors have verified the distance L2 from the center of gravity CG2 to the extension line of the axis, which is effective for preventing the ceramic housing 60 from being fixed in a state of being inclined from the axial direction. As a result, the present inventors have confirmed that by setting the distance L2 from the center of gravity CG2 to the extension line of the axis to be within 2 mm, it is possible to remarkably prevent the ceramic housing 60 from being fixed in a state of being inclined from the axial direction as compared with a case where the distance L2 is set to be larger than 2 mm.

In the gas sensor 1, the distance L2 from a position of the center of gravity CG2 of a portion of the elastic body 50 in contact with the spacer 70 to the extension line of the axis of the sensor element 10 (gas sensor 1) is within 2 mm.

Therefore, the gas sensor 1 achieves an effect of being able to remarkably prevent the ceramic housing 60 from being fixed in a state of being inclined from the axial direction as compared with a case where the distance L2 from the center of gravity CG2 to the extension line of the axis is larger than 2 mm.

Here, as described above, the gas sensor 1 is manufactured, for example, through the above-described swaging process. However, when the elastic body 50 is deformed in the swaging process and stress acts in a direction inclined from the axial direction from the elastic body 50 to the spacer 70, as a result, the ceramic housing 60 in contact with the spacer 70 may also be inclined from the axial direction.

In view of the above, for example, by bringing the elastic body 50 and the spacer 70 into contact with each other on the extension line of the axis in the swaging process, the gas sensor 1 can prevent the ceramic housing 60 from being inclined from the axial direction. Specifically, in the swaging process, the distance L2 from the center of gravity CG2 to the extension line of the axis is set to be within 2 mm. By the above, the gas sensor 1 can prevent occurrence of an event in which “the ceramic housing 60 is positioned in a state of being inclined from the axial direction in the swaging process”.

Note that, in the gas sensor 1 illustrated in FIGS. 1 and 2, a rear end surface of the spacer 70 and a front end surface of the elastic body 50 are similar in area and shape, that is, they are substantially equal in area and shape.

By making a rear end surface of the spacer 70 and a front end surface of the elastic body 50 substantially equal (similar) in area and shape, the gas sensor 1 has an effect below. That is, in a case where a rear end surface of the spacer 70 and a front end surface of the elastic body 50 are similar to each other, it is easy to bring the rear end surface and the front end surface into contact with each other on the extension line of the axis of the sensor element 10, for example, in a manufacturing stage of the gas sensor 1 and the like, as compared with a case where the rear end surface and the front end surface are different from each other. In particular, by making a rear end surface of the spacer 70 and a front end surface of the elastic body 50 similar to each other, it is easy to reduce the distance L2 from the center of gravity CG2 of a contact portion between the rear end surface and the front end surface to the extension line of the axis of the sensor element 10 (for example, to be within 2 mm) in the manufacturing stage or the like. That a rear end surface of the spacer 70 and a front end surface of the elastic body 50 are “similar” means that, for example, a difference in area between the rear end surface and the front end surface is about 40% or less of an area of at least one of the rear end surface of the spacer 70 and the front end surface of the elastic body 50.

However, in the gas sensor 1, it is not essential to make a rear end surface of the spacer 70 similar to a front end surface of the elastic body 50, and for example, it is not essential to make a rear end surface of the spacer 70 and a front end surface of the elastic body 50 substantially equal in area and shape. In the gas sensor according to one aspect of the present invention, a rear end surface of the spacer and a front end surface of the elastic body may be similar to or different from each other.

For example, in the gas sensor 1, a rear end surface of the spacer 70 may be larger than a front end surface of the elastic body 50. By making a rear end surface of the spacer 70 larger than a front end surface of the elastic body 50, the gas sensor 1 has an effect below. That is, in a case where a rear end surface of the spacer 70 is larger than a front end surface of the elastic body 50, it is easy to sufficiently secure the contact area A2 between them, for example, in a manufacturing stage of the gas sensor 1 and the like as compared with a case where the rear end surface is smaller than the front end surface. Specifically, in a case where a rear end surface of the spacer 70 is larger than a front end surface of the elastic body 50, it is easy to set the contact area A2 between the rear end surface and the front end surface to 25% or more of an entire area of the front end surface of the elastic body, as compared with a case where the rear end surface is smaller than the front end surface.

Further, in the gas sensor 1, a rear end surface of the spacer 70 may be smaller than a front end surface of the elastic body 50. However, as described above, the contact area A2 between the spacer 70 and the elastic body 50 is desirably 25% or more of an entire area of a front end surface of the elastic body 50. Further, the distance L2 from the center of gravity CG2 of a contact surface between the elastic body 50 and the spacer 70 to the extension line of the axis is desirably set to be sufficiently small, and specifically, the distance L2 is desirably set to be within 2 mm.

### (Regarding Direction of End Surface of Each of Ceramic Housing, Spacer, and Elastic Body)

In the gas sensor 1, the ceramic housing 60 is arranged along the axial direction, that is, the ceramic housing 60 is arranged inside the tubular body 20 (outer tube 22) in a state of extending in the axial direction. In accordance with arrangement of the ceramic housing 60 along the axial direction, for example, a rear end surface of the ceramic housing 60 is orthogonal to the axial direction. Further, in the gas sensor 1, a front end surface of the spacer 70 in contact with a rear end surface of the ceramic housing 60 is desirably also orthogonal to the axial direction.

In addition to a rear end surface of the ceramic housing 60, a front end surface of the spacer 70 is also orthogonal to the axial direction, so that the gas sensor 1 can more effectively prevent the ceramic housing 60 from being inclined from the axial direction in a case where an impact is applied to the gas sensor 1.

The spacer 70 is desirably arranged along the axial direction in accordance with a front end surface of the spacer 70 being orthogonal to the axial direction. In the gas sensor 1, a rear end surface of the spacer 70 is desirably orthogonal to the axial direction. Similarly, in the gas sensor 1, a front end surface of the elastic body 50 in contact with the spacer 70 (in particular, a rear end surface of the spacer 70) is also desirably orthogonal to the axial direction. Since all of a front end surface of the elastic body 50 and a rear end surface and a front end surface of the spacer 70 are orthogonal to the axial direction, the gas sensor 1 has an effect below. That is, the gas sensor 1 can extremely effectively prevent the ceramic housing 60 from being inclined from the axial direction also in a case where an impact is applied to the gas sensor 1 and the like, for example.

### <Consideration on Configuration of Spacer>

As described above, the gas sensor according to one aspect of the present invention solves a problem of the conventional gas sensor that “a ceramic housing bites into an elastic body arranged on the rear end side of the ceramic housing in a state of being inclined from the axial direction” by a configuration below. That is, the gas sensor according to one aspect of the present invention solves the above-described problem of the conventional gas sensor as the spacer, particularly the spacer in which a front end portion including a front end surface is sufficiently hard, is arranged on the rear end side of the ceramic housing. Specifically, the gas sensor according to one aspect of the present invention solves the above-described problem of the conventional gas sensor as the spacer “having Young's modulus of 80 GPa or more at a front end portion” is arranged on the rear end side of the ceramic housing.

For this reason, in the gas sensor according to one aspect of the present invention, the spacer arranged on the rear end side of the ceramic housing (that is, in contact with a rear end surface of the ceramic housing) only needs to have Young's modulus of 80 GPa or more at least at a front end portion including a front end surface of the spacer. For example, in the gas sensor 1 described with reference to FIGS. 1 and 2, the spacer 70 arranged on the rear end side of the ceramic housing 60 (that is, in contact with a rear end surface of the ceramic housing 60) has Young's modulus of 80 GPa or more as a whole.

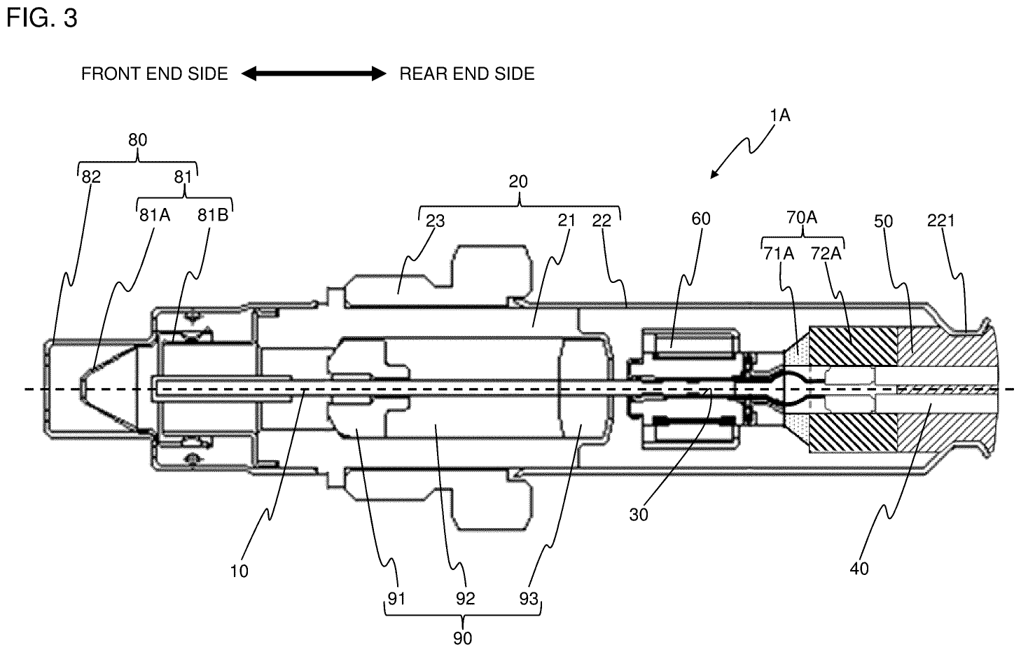

However, for the gas sensor according to one aspect of the present invention, it is not essential that Young's modulus of the “entire” spacer arranged on the rear end side of the ceramic housing be 80 GPa or more. As described above, in the gas sensor according to one aspect of the present invention, the spacer arranged on the rear end side of the ceramic housing may have at least Young's modulus of 80 GPa or more at a front end portion including a front end surface of the spacer. For example, in the gas sensor according to one aspect of the present invention, the spacer arranged on the rear end side of the ceramic housing may be hard on the front end side and soft on the rear end side. Hereinafter, the gas sensor including the spacer “arranged on the rear end side of the ceramic housing, and having the front end side being hard and the rear end side being soft” according to one aspect of the present invention will be described with reference to FIG. 3.

FIG. 3 is a schematic cross-sectional view schematically illustrating an example of a main configuration of a gas sensor 1A according to a first variation. In FIG. 3, a left-right direction on the diagram is the axial direction (longitudinal direction) of the gas sensor 1A, the left side in the diagram is the front end side, and the right side in the diagram is the rear end side. The gas sensor 1A includes a spacer 70A “arranged on the rear end side of the ceramic housing 60, and having the front end side being hard and the rear end side being soft”. The gas sensor 1A exemplified in FIG. 3 is similar to the gas sensor 1 described with reference to FIGS. 1 and 2 except that the spacer 70A is provided instead of the spacer 70. For this reason, in description below, detailed description of a configuration other than the “spacer 70A” is omitted.

As exemplified in FIG. 3, in the gas sensor 1A, the spacer 70A includes a front end portion 71A and a rear end portion 72A. The spacer 70A is arranged inside the tubular body 20 (outer tube 22) in a manner that the front end portion 71A is arranged on the front end side in the axial direction and the rear end portion 72A is arranged on the rear end side in the axial direction. The front end portion 71A and the rear end portion 72A have different hardness (softness) from each other, and specifically, have different Young's modulus from each other. That is, Young's modulus of the front end portion 71A is 80 GPa or more, whereas Young's modulus of the rear end portion 72A is less than 80 GPa.

FIGS. 1 and 2 illustrate an example of the gas sensor 1 in which the spacer 70 is one member. On the other hand, in the gas sensor 1A exemplified in FIG. 3, the spacer 70A arranged on the rear end side of the ceramic housing 60 includes a plurality of constituent elements (constituent members). In the gas sensor according to one aspect of the present invention, the spacer arranged on the rear end side of the ceramic housing may include a plurality of constituent elements (constituent members), and Young's modulus of at least a front end portion only needs to be 80 GPa or more. In the gas sensor according to one aspect of the present invention, the spacer may include a spacer front end side portion arranged on the front end side in the axial direction and a spacer rear end side portion arranged on the rear end side, and Young's moduli of the spacer front end side portion and the spacer rear end side portion may be different. In the gas sensor according to one aspect of the present invention, the spacer may have, for example, a multistage configuration (as an example, a two-stage configuration) including the spacer front end side portion and the spacer rear end side portion described above. For example, the spacer 70A exemplified in FIG. 3 has a two-stage configuration including the front end portion 71A arranged on the front end side in the axial direction and the rear end portion 72A arranged on the rear end side. Note that it is not essential that the spacer 70A have a two-stage configuration, and the spacer 70A may further include an intermediate portion between the front end portion 71A and the rear end portion 72A, that is, may have a configuration of three or more stages.

In the gas sensor 1A, the ceramic housing 60 is in contact with the spacer 70A arranged on the rear end side of the ceramic housing 60, specifically, a front end surface of the spacer 70A (in particular, the front end portion 71A). In the spacer 70A, Young's modulus of the front end portion 71A including a front end surface with which the ceramic housing 60 (in particular, a rear end surface of the ceramic housing 60) is in contact is 80 GPa or more. By setting Young's modulus of the front end portion 71A including a front end surface, with which the ceramic housing 60 is in contact, of the spacer 70A to 80 GPa or more, the gas sensor 1A has an effect below. That is, the gas sensor 1A achieves an effect of being able to prevent the ceramic housing 60 from biting into a member (that is, the spacer 70A) arranged on the rear end side of the ceramic housing 60 in a state of being inclined from the axial direction.

As described above, the spacer 70A includes the front end portion 71A including a front end surface of the spacer 70A and the rear end portion 72A including a rear end surface of the spacer 70A. In the spacer 70A, the rear end portion 72A is softer than the front end portion 71A, and specifically, Young's modulus of the rear end portion 72A is smaller than Young's modulus of the front end portion 71A. That is, Young's modulus of the front end portion 71A is 80 GPa or more, whereas Young's modulus of the rear end portion 72A is less than 80 GPa.

That is, in the gas sensor 1A, the rear end portion 72A of the spacer 70A is softer and more easily bent than the front end portion 71A of the spacer 70A. Then, in the gas sensor 1A, the spacer 70A is in contact with the elastic body 50 (in particular, a front end surface of the elastic body 50) on the rear end surface of the spacer 70A

For this reason, if a front end surface of the elastic body 50 is inclined with respect to the axial direction in the gas sensor 1A, inclination of the front end surface of the elastic body 50 can be absorbed by the rear end portion 72A of the spacer 70A. That is, in the gas sensor 1A, as the soft rear end portion 72A of the spacer 70A in contact with a front end surface of the elastic body 50 is bent, inclination of a front end surface of the elastic body 50 can be absorbed in the rear end portion 72A of the spacer 70A.

The spacer 70A prevents “inclination of a front end surface of the elastic body 50 from being transmitted to the ceramic housing 60 via the spacer 70A, and the ceramic housing 60 from being inclined from the axial direction” by the rear end portion 72A that is softer and more easily bent than the front end portion 71A. For example, in a case where a front end surface of the elastic body 50 is inclined from the axial direction, stress in a direction inclined from the axial direction may be transmitted from a front end surface of the elastic body 50 to the ceramic housing 60, and the ceramic housing 60 may be inclined from the axial direction due to such stress. The spacer 70A prevents such an event by the rear end portion 72A which is softer and more easily bent than the front end portion 71A. That is, the spacer 70A prevents occurrence of an event in which the ceramic housing 60 is inclined from the axial direction due to stress in a direction inclined from the axial direction from a front end surface of the elastic body 50 by absorbing the stress by the rear end portion 72A. Moreover, the front end portion 71A of the spacer 70A has sufficient hardness that can remarkably prevent the ceramic housing 60 from biting into the spacer 70A.

Therefore, the gas sensor 1A achieves an effect of being able to more effectively prevent the ceramic housing 60 from biting into a member (that is, the spacer 70A) arranged on the rear end side of the ceramic housing 60 in a state of being inclined from the axial direction.

In a case where the spacer 70A is used to reduce temperature rise of the elastic body 50 during use of the gas sensor 1A, each of the front end portion 71A and the rear end portion 72A described above may be configured as described below. That is, as a material of the front end portion 71A arranged on the front end side in the axial direction, ceramics having a melting point higher than that of resin is selected from the viewpoint of heat resistance superior to that of the rear end portion 72A. Preferably, ceramics having thermal conductivity of 32 W/m·K or less, which is suitable also from the viewpoint of heat insulation property in addition to heat resistance, is selected, and more preferably, alumina (thermal conductivity: 32 W/m·K) or steatite (thermal conductivity: 2 W/m·K) is selected. On the other hand, as a material of the rear end portion 72A in contact with the elastic body 50, resin is selected rather than ceramics and the like from the viewpoint of low thermal conductivity. Preferably, resin used for the rear end portion 72A is polytetrafluoroethylene (PTFE, melting point: 327° C.) or PFA (perfluoroalkoxy alkane, melting point: 310° C.) which is fluororesin. These types of resin have higher heat resistance than the elastic body 50 made from rubber in addition to low thermal conductivity. For example, PTFE has thermal conductivity of 0.2 W/m·K, and continuous maximum use temperature (maximum temperature in a case where use at the maximum temperature continues) of 260° C.

That is, in the gas sensor 1A, at least a portion of the spacer 70A is made from ceramics, and for example, the front end portion 71A of the spacer 70A is made from ceramics. Ceramics have excellent heat resistance and generally have a higher melting point than resin. Then, in the gas sensor 1A, the spacer 70A is arranged further on the front end side in the axial direction than the elastic body 50, and in particular, the front end portion 71A of the spacer 70A is arranged further on the front end side in the axial direction than the rear end portion 72A. When the front end portion 71A of the spacer 70A is made from ceramics having excellent heat resistance, the gas sensor 1A achieves an effect below. That is, the gas sensor 1A achieves an effect of being able to prevent occurrence of an event in which the front end portion 71A of the spacer 70A is eroded by heat generated from a heat source on the front end side of the gas sensor 1A. However, it is not essential for the gas sensor 1A that the front end portion 71A of the spacer 70A be made from ceramics, and, in the gas sensor 1A, a material having heat resistance may be appropriately used as a material of the front end portion 71A of the spacer 70A.

In the gas sensor 1A, a contact area A1(A) between the spacer 70A (in particular, the front end portion 71A) and the ceramic housing 60 is 3 mm² or more, similarly to the contact area A1 in the gas sensor 1. By setting the contact area A1(A) between the spacer 70A (in particular, a front end surface of the spacer 70A) and the ceramic housing 60 (in particular, a rear end surface of the ceramic housing 60) to 3 mm² or more, the gas sensor 1A achieves an effect below similarly to the gas sensor 1. That is, the gas sensor 1A achieves an effect of being able to remarkably prevent the ceramic housing 60 from being fixed in a state of being inclined from the axial direction as compared with a case where the contact area A1(A) between the spacer 70A and the ceramic housing 60 is less than 3 mm².

In the gas sensor 1A, an area (contact area A2(A)) of a portion in contact with the spacer 70A (in particular, the rear end portion 72A) on a front end surface of the elastic body 50 is 25% or more of an entire area of a front end surface of the elastic body 50, similarly to the contact area A2 in the gas sensor 1. By setting the contact area A2(A) between the elastic body 50 (in particular, a front end surface of the elastic body 50) and the spacer 70A (in particular, a rear end surface of the spacer 70A) to be 25% or more of an entire area of the front end surface of the elastic body 50, the gas sensor 1A achieves an effect below similarly to the gas sensor 1. That is, the gas sensor 1A achieves an effect of being able to remarkably prevent the ceramic housing 60 from being fixed in a state of being inclined from the axial direction as compared with a case where the contact area A2(A) is less than 25% of an entire area of a front end surface of the elastic body 50.

In the gas sensor 1A, a distance L1(A) from a position of a center of gravity CG1(A) of a portion of the spacer 70A in contact with the ceramic housing 60 to the extension line of the axis of the sensor element 10 (gas sensor 1) is within 2 mm, similarly to the distance L1 in the gas sensor 1. The center of gravity CG1(A) is the center of mass when mass is virtually uniformly distributed in a portion in contact with the ceramic housing 60 (in particular, a rear end surface of the ceramic housing 60) on a front end surface of the spacer 70A (in particular, the front end portion 71A). By setting the distance L1(A) from a position of the center of gravity CG1(A) of a portion of the spacer 70A in contact with the ceramic housing 60 to the extension line of the axis of the sensor element 10 to be within 2 mm, the gas sensor 1A achieves an effect below similarly to the gas sensor 1. That is, the gas sensor 1A achieves an effect of being able to remarkably prevent the ceramic housing 60 from being fixed in a state of being inclined from the axial direction as compared with a case where the distance L1(A) from the center of gravity CG1(A) to the extension line of the axis of the sensor element 10 is larger than 2 mm.

In the gas sensor 1A, a distance L2(A) from a position of a center of gravity CG2(A) of a portion of the elastic body 50 in contact with the spacer 70A to the extension line of the axis of the sensor element 10 (gas sensor 1) is within 2 mm. The center of gravity CG2(A) is the center of mass when mass is virtually uniformly distributed in a portion in contact with the spacer 70A (in particular, a rear end surface of the spacer 70A) on a front end surface of the elastic body 50. By setting the distance L2(A) from a position of the center of gravity CG2(A) of a portion of the elastic body 50 in contact with the spacer 70A to the extension line of the axis of the sensor element 10 to be within 2 mm, the gas sensor 1A achieves an effect below similarly to the gas sensor 1. That is, the gas sensor 1A achieves an effect of being able to remarkably prevent the ceramic housing 60 from being fixed in a state of being inclined from the axial direction as compared with a case where the distance L2(A) from the center of gravity CG2(A) to the extension line of the axis of the sensor element 10 is larger than 2 mm.

In the gas sensor 1A, a material of the elastic body 50 is fluororubber, similarly to the elastic body 50 in the gas sensor 1. For this reason, similarly to the gas sensor 1, the gas sensor 1A achieves an effect of being able to maintain and improve detection accuracy of gas concentration by securing sealability of the elastic body 50 under a high-temperature environment, for example.

Note that in the gas sensor 1A exemplified in FIG. 3, a front end surface of the spacer 70A (front end portion 71A) and a rear end surface of the ceramic housing 60 are similar in area and shape, that is, they are substantially equal in area and shape.

By making a front end surface of the spacer 70A and a rear end surface of the ceramic housing 60 substantially equal (similar) in area and shape, the gas sensor 1A achieves an effect below. That is, in a case where a front end surface of the spacer 70A and a rear end surface of the ceramic housing 60 are similar to each other, it is easy to bring the front end surface and the rear end surface into contact with each other on the extension line of the axis of the sensor element 10, for example, in a manufacturing stage of the gas sensor 1A and the like, as compared with a case where the front end surface and the rear end surface are different from each other. In particular, by making a front end surface of the spacer 70A and a rear end surface of the ceramic housing 60 similar to each other, it is easy to reduce the distance L1 from the center of gravity CG1 of a contact portion between the front end surface and the rear end surface to the extension line of the axis of the sensor element 10 (for example, to be within 2 mm) in the manufacturing stage or the like. Here, that a front end surface of the spacer 70A and a rear end surface of the ceramic housing 60 are “similar” means that, for example, the front end surface and the rear end surface are circular or elliptical, and a difference in area between them is about 40% or less of an area of at least one of them.

However, in the gas sensor 1A, it is not essential to make a front end surface of the spacer 70A similar to a rear end surface of the ceramic housing 60, and for example, it is not essential to make the front end surface and the rear end surface substantially equal in area and shape. In the gas sensor according to one aspect of the present invention, a front end surface of the spacer and a rear end surface of the ceramic housing may be similar to or different from each other.

For example, in the gas sensor 1A, a front end surface of the spacer 70A may be smaller than a rear end surface of the ceramic housing 60. Similarly, in the gas sensor 1A, a front end surface of the spacer 70A may be larger than a rear end surface of the ceramic housing 60. By making a front end surface of the spacer 70A larger than a rear end surface of the ceramic housing 60, the gas sensor 1A achieves an effect below. That is, in a case where a front end surface of the spacer 70A is larger than a rear end surface of the ceramic housing 60, it is easy to sufficiently secure the contact area A1(A) between them, for example, in a manufacturing stage of the gas sensor 1A and the like as compared with a case where the front end surface is smaller than the rear end surface. Specifically, in a case where a front end surface of the spacer 70A is larger than a rear end surface of the ceramic housing 60, it is easy to set the contact area A1(A) to 3 mm² in a manufacturing stage of the gas sensor 1A and the like as compared with a case where the front end surface is smaller than the rear end surface.

Further, in the gas sensor 1A illustrated in FIG. 3, a rear end surface of the spacer 70A and a front end surface of the elastic body 50 are similar in area and shape, that is, they are substantially equal in area and shape.

By making a rear end surface of the spacer 70A and a front end surface of the elastic body 50 substantially equal (similar) in area and shape, the gas sensor 1A has an effect below. That is, in a case where a rear end surface of the spacer 70A and a front end surface of the elastic body 50 are similar to each other, it is easy to bring the rear end surface and the front end surface into contact with each other on the extension line of the axis of the sensor element 10, for example, in a manufacturing stage of the gas sensor 1A and the like, as compared with a case where the rear end surface and the front end surface are different from each other. In particular, by making a rear end surface of the spacer 70A and a front end surface of the elastic body 50 similar to each other, it is easy to reduce the distance L2(A) from the center of gravity CG2(A) of a contact portion between the rear end surface and the front end surface to the extension line of the axis of the sensor element 10 (for example, to be within 2 mm) in the manufacturing stage or the like. That a rear end surface of the spacer 70A and a front end surface of the elastic body 50 are “similar” means that, for example, a difference in area between the rear end surface and the front end surface is about 40% or less of an area of at least one of the rear end surface of the spacer 70A and the front end surface of the elastic body 50.

However, in the gas sensor 1A, it is not essential to make a rear end surface of the spacer 70A similar to a front end surface of the elastic body 50, and for example, it is not essential to make a rear end surface of the spacer 70A and a front end surface of the elastic body 50 substantially equal in area and shape. In the gas sensor according to one aspect of the present invention, a rear end surface of the spacer and a front end surface of the elastic body may be similar to or different from each other.

For example, in the gas sensor 1A, a rear end surface of the spacer 70A may be larger than a front end surface of the elastic body 50. By making a rear end surface of the spacer 70A larger than a front end surface of the elastic body 50, the gas sensor 1A has an effect below. That is, in a case where a rear end surface of the spacer 70A is larger than a front end surface of the elastic body 50, it is easy to sufficiently secure the contact area A2(A) between them, for example, in a manufacturing stage of the gas sensor 1A and the like as compared with a case where the rear end surface is smaller than the front end surface. Specifically, in a case where a rear end surface of the spacer 70A is larger than a front end surface of the elastic body 50, it is easy to set the contact area A2(A) between the rear end surface and the front end surface to 25% or more of an entire area of the front end surface of the elastic body, as compared with a case where the rear end surface is smaller than the front end surface.

Further, in the gas sensor 1A, a rear end surface of the spacer 70A may be smaller than a front end surface of the elastic body 50. However, as described above, the contact area A2(A) between the spacer 70A and the elastic body 50 is desirably 25% or more of an entire area of a front end surface of the elastic body 50. Further, the distance L2(A) from the center of gravity CG2(A) of a contact surface between the elastic body 50 and the spacer 70A to the extension line of the axis is desirably set to be sufficiently small, and specifically, the distance L2(A) is desirably set to be within 2 mm.

### (Regarding Direction of End Surface of Each of Ceramic Housing, Spacer, and Elastic Body)

In the gas sensor 1A, the ceramic housing 60 is arranged along the axial direction, that is, the ceramic housing 60 is arranged inside the tubular body 20 (outer tube 22) in a state of extending in the axial direction. In accordance with arrangement of the ceramic housing 60 along the axial direction, for example, a rear end surface of the ceramic housing 60 is orthogonal to the axial direction. Further, in the gas sensor 1A, a front end surface of the spacer 70A (in particular, the front end portion 71A) in contact with a rear end surface of the ceramic housing 60 is desirably also orthogonal to the axial direction.

In addition to a rear end surface of the ceramic housing 60, a front end surface of the spacer 70A (in particular, the front end portion 71A) is also orthogonal to the axial direction, so that the gas sensor 1A has an effect below. That is, the gas sensor 1A can more effectively prevent the ceramic housing 60 from being inclined from the axial direction in a case where an impact is applied to the gas sensor 1A and the like, for example.

Note that, as described above, in the spacer 70A, the rear end portion 72A is softer than the front end portion 71A, that is, the rear end portion 72A is more easily bent than the front end portion 71A. For this reason, if a front end surface of the elastic body 50 is inclined from a direction orthogonal to the axial direction, the spacer 70A absorbs the inclination of the front end surface of the elastic body 50 by bending of the rear end portion 72A, and prevents the spacer 70A (in particular, a front end surface of the spacer 70A) from being inclined from the axial direction. Then, the gas sensor 1A can prevent the ceramic housing 60 from being inclined from the axial direction by preventing the spacer 70A (in particular, a front end surface of the spacer 70A) from being inclined from the axial direction. Therefore, in the gas sensor 1A, a rear end surface of the spacer 70A (rear end portion 72A) does not need to be orthogonal to the axial direction. However, in the gas sensor 1A, a rear end surface of the spacer 70A may be orthogonal to the axial direction. Similarly, in the gas sensor 1A, a front end surface of the elastic body 50 in contact with the spacer 70A (in particular, a rear end surface of the spacer 70A) may not be orthogonal to the axial direction or may be orthogonal to the axial direction.

### <Consideration on Shape of Spacer>

Each of the gas sensors 1 and 1A described above includes the spacer “arranged on the rear end side of the ceramic housing 60, and having the front end side being hard (specifically, having Young's modulus of 80 GPa or more) and a front end surface being similar to a rear end surface of the ceramic housing”.

By making a front end surface of the spacer similar to a rear end surface of the ceramic housing, for example, by making the front end surface of the spacer and the rear end surface of the ceramic housing substantially equal in area and shape, the gas sensor according to one aspect of the present invention achieves an effect below. That is, in a case where a front end surface of the spacer and a rear end surface of the ceramic housing are similar to each other, it is easy to bring the front end surface and the rear end surface into contact with each other on the extension line of the axis of the sensor element (gas sensor), for example, in a manufacturing stage of the gas sensor and the like, as compared with a case where the front end surface and the rear end surface are different from each other. In particular, by making a front end surface of the spacer and a rear end surface of the ceramic housing substantially equal in area and shape, it is easy to reduce the “distance from the center of gravity of a contact portion between the front end surface and the rear end surface to the extension line of the axis of the sensor element 10” (for example, to be within 2 mm) in the manufacturing stage or the like. However, in the gas sensor according to one aspect of the present invention, it is not essential that a front end surface of the spacer and a rear end surface of the ceramic housing be similar, and for example, it is not essential that the front end surface and the rear end surface be substantially equal in area and shape. In the gas sensor according to one aspect of the present invention, a front end surface of the spacer and a rear end surface of the ceramic housing may be similar to or different from each other. In the gas sensor according to one aspect of the present invention, the spacer arranged on the rear end side of the ceramic housing (that is, in contact with a rear end surface of the ceramic housing) only needs to have Young's modulus of 80 GPa or more at least at a front end portion including a front end surface of the spacer. In the gas sensor according to one aspect of the present invention, a shape of the spacer “arranged on the rear end side of the ceramic housing 60, and having the front end side being hard” is not particularly limited, and for example, a front end surface of the spacer may be larger than a rear end surface of the ceramic housing. Hereinafter, as the gas sensor according to one aspect of the present invention, an example of a gas sensor including a spacer “that has a front end surface larger than a rear end surface of the ceramic housing 60, and in which Young's modulus of a front end portion including the front end surface is 80 GPa or more” will be described with reference to FIG. 4.

FIG. 4 is a schematic cross-sectional view schematically illustrating an example of a main configuration of the gas sensor 1B according to a second variation. In FIG. 4, the left-right direction in the diagram is the axial direction (longitudinal direction) of the gas sensor 1B, and the left side in the diagram is the front end side and the right side in the diagram is the rear end side. The gas sensor 1B includes a spacer 70B “that has a front end surface larger than a rear end surface of the ceramic housing 60, and in which Young's modulus of a front end portion including the front end surface is 80 GPa or more”. The gas sensor 1B exemplified in FIG. 4 is similar to the gas sensor 1 described with reference to FIGS. 1 and 2 except that the spacer 70B is provided instead of the spacer 70. For this reason, in description below, detailed description of a configuration other than the “spacer 70B” is omitted.

In the gas sensor 1B, a front end surface of the spacer 70B is larger than a rear end surface of the ceramic housing 60 in contact with the front end surface of the spacer 70B. In the gas sensor according to one aspect of the present invention, it is not essential that a front end surface of the spacer arranged on the rear end side of the ceramic housing be similar in area and shape to the rear end surface of the ceramic housing.

By making a front end surface of the spacer 70B larger than a rear end surface of the ceramic housing 60, the gas sensor 1B achieves an effect below. That is, in a case where a front end surface of the spacer 70B is larger than a rear end surface of the ceramic housing 60, it is easy to sufficiently secure a contact area A1(B) between them, for example, in a manufacturing stage of the gas sensor 1B and the like as compared with a case where the front end surface is smaller than the rear end surface. Specifically, in a case where a front end surface of the spacer 70B is larger than a rear end surface of the ceramic housing 60, it is easy to set the contact area A1(B) to 3 mm² in a manufacturing stage of the gas sensor 1B and the like as compared with a case where the front end surface is smaller than the rear end surface.

In the gas sensor 1B, the ceramic housing 60 is in contact with the spacer 70B arranged on the rear end side of the ceramic housing 60, specifically, a front end surface of the spacer 70B. In the spacer 70B, Young's modulus of a front end portion including a front end surface with which the ceramic housing 60 (in particular, a rear end surface of the ceramic housing 60) is in contact is 80 GPa or more. That is, in the gas sensor 1B, Young's modulus of the entire spacer 70B is 80 GPa or more, that is, Young's modulus of the entire spacer 70B including a front end portion is 80 GPa or more. By setting Young's modulus of the entire spacer 70B, particularly Young's modulus of a front end portion of the spacer 70B including a front end surface with which the ceramic housing 60 is in contact to 80 GPa or more, the gas sensor 1B achieves an effect below. That is, the gas sensor 1B achieves an effect of being able to prevent the ceramic housing 60 from biting into a member (that is, the spacer 70B) arranged on the rear end side of the ceramic housing 60 in a state of being inclined from the axial direction.

In the gas sensor 1B, the contact area A1(B) between the spacer 70B (in particular, a front end surface of the spacer 70B) and the ceramic housing 60 (in particular, a rear end surface of the ceramic housing 60) is 3 mm² or more, similarly to the contact area A1 in the gas sensor 1. By setting the contact area A1(B) between the spacer 70B (in particular, a front end surface of the spacer 70B) and the ceramic housing 60 (in particular, a rear end surface of the ceramic housing 60) to 3 mm² or more, the gas sensor 1B achieves an effect below similarly to the gas sensor 1. That is, the gas sensor 1B achieves an effect of being able to remarkably prevent the ceramic housing 60 from being fixed in a state of being inclined from the axial direction as compared with a case where the contact area A1(B) between the spacer 70B and the ceramic housing 60 is less than 3 mm².

In the gas sensor 1B, an area (contact area A2(B)) of a portion in contact with the spacer 70B (in particular, a rear end surface of the spacer 70B) on a front end surface of the elastic body 50 is 25% or more of an entire area of a front end surface of the elastic body 50, similarly to the contact area A2 in the gas sensor 1. By setting the contact area A2(B) between the elastic body 50 (in particular, a front end surface of the elastic body 50) and the spacer 70B (in particular, a rear end surface of the spacer 70B) to be 25% or more of an entire area of the front end surface of the elastic body 50, the gas sensor 1B achieves an effect below similarly to the gas sensor 1. That is, the gas sensor 1B achieves an effect of being able to remarkably prevent the ceramic housing 60 from being fixed in a state of being inclined from the axial direction as compared with a case where the contact area A2(B) is less than 25% of an entire area of a front end surface of the elastic body 50.

In the gas sensor 1B, a distance L1(B) from a position of a center of gravity CG1(B) of a portion of the spacer 70B in contact with the ceramic housing 60 to the extension line of the axis of the sensor element 10 (gas sensor 1) is within 2 mm, similarly to the distance L1 in the gas sensor 1. The center of gravity CG1(B) is the center of mass when mass is virtually uniformly distributed in a portion in contact with the ceramic housing 60 (in particular, a rear end surface of the ceramic housing 60) on a front end surface of the spacer 70B. By setting the distance L1(B) from a position of the center of gravity CG1(B) of a portion of the spacer 70B in contact with the ceramic housing 60 to the extension line of the axis of the sensor element 10 to be within 2 mm, the gas sensor 1B achieves an effect below similarly to the gas sensor 1. That is, the gas sensor 1B achieves an effect of being able to remarkably prevent the ceramic housing 60 from being fixed in a state of being inclined from the axial direction as compared with a case where the distance L1(B) from the center of gravity CG1(B) to the extension line of the axis of the sensor element 10 is larger than 2 mm.

In the gas sensor 1B, a distance L2(B) from a position of a center of gravity CG2(B) of a portion of the elastic body 50 in contact with the spacer 70B to the extension line of the axis of the sensor element 10 (gas sensor 1) is within 2 mm. The center of gravity CG2(B) is the center of mass when mass is virtually uniformly distributed in a portion in contact with the spacer 70B (in particular, a rear end surface of the spacer 70B) on a front end surface of the elastic body 50. By setting the distance L2(B) from a position of the center of gravity CG2(B) of a portion of the elastic body 50 in contact with the spacer 70B to the extension line of the axis of the sensor element 10 to be within 2 mm, the gas sensor 1B achieves an effect below similarly to the gas sensor 1. That is, the gas sensor 1B achieves an effect of being able to remarkably prevent the ceramic housing 60 from being fixed in a state of being inclined from the axial direction as compared with a case where the distance L2(B) from the center of gravity CG2(B) to the extension line of the axis of the sensor element 10 is larger than 2 mm.

In the gas sensor 1B, a material of the elastic body 50 is fluororubber, similarly to the elastic body 50 in the gas sensor 1. For this reason, similarly to the gas sensor 1, the gas sensor 1B achieves an effect of being able to maintain and improve detection accuracy of gas concentration by securing sealability of the elastic body 50 under a high-temperature environment, for example.

In the gas sensor 1B, at least a portion of the spacer 70B is made from ceramics, and specifically, the entire spacer 70B is made from ceramics. Ceramics have excellent heat resistance and generally have a higher melting point than resin. Then, in the gas sensor 1B, the spacer 70B is arranged further on the front end side in the axial direction than the elastic body 50. When the spacer 70B is made from ceramics having excellent heat resistance, the gas sensor 1B achieves an effect below. That is, the gas sensor 1B achieves an effect of being able to prevent occurrence of an event in which the spacer 70B is eroded by heat generated from a heat source on the front end side of the gas sensor 1B. However, it is not essential for the gas sensor 1B that the spacer 70B be made from ceramics, and, in the gas sensor 1B, a material having heat resistance may be appropriately used as a material of the spacer 70B.

In the gas sensor 1B illustrated in FIG. 4, a rear end surface of the spacer 70B and a front end surface of the elastic body 50 are similar in area and shape, that is, they are substantially equal in area and shape.

By making a rear end surface of the spacer 70B and a front end surface of the elastic body 50 substantially equal (similar) in area and shape, the gas sensor 1B has an effect below. That is, in a case where a rear end surface of the spacer 70B and a front end surface of the elastic body 50 are similar to each other, it is easy to bring the rear end surface and the front end surface into contact with each other on the extension line of the axis of the sensor element 10, for example, in a manufacturing stage of the gas sensor 1B and the like, as compared with a case where the rear end surface and the front end surface are different from each other. In particular, by making a rear end surface of the spacer 70B and a front end surface of the elastic body 50 similar to each other, it is easy to reduce the distance L2(B) from the center of gravity CG2(B) of a contact portion between the rear end surface and the front end surface to the extension line of the axis of the sensor element 10 (for example, to be within 2 mm) in the manufacturing stage or the like. That a rear end surface of the spacer 70B and a front end surface of the elastic body 50 are “similar” means that, for example, a difference in area between the rear end surface and the front end surface is about 40% or less of an area of at least one of the rear end surface of the spacer 70B and the front end surface of the elastic body 50.

However, in the gas sensor 1B, it is not essential to make a rear end surface of the spacer 70B similar to a front end surface of the elastic body 50, and for example, it is not essential to make a rear end surface of the spacer 70B and a front end surface of the elastic body 50 substantially equal in area and shape. In the gas sensor according to one aspect of the present invention, a rear end surface of the spacer and a front end surface of the elastic body may be similar to or different from each other.

For example, in the gas sensor 1B, a rear end surface of the spacer 70B may be larger than a front end surface of the elastic body 50. By making a rear end surface of the spacer 70B larger than a front end surface of the elastic body 50, the gas sensor 1B has an effect below. That is, in a case where a rear end surface of the spacer 70B is larger than a front end surface of the elastic body 50, it is easy to sufficiently secure the contact area A2(B) between them, for example, in a manufacturing stage of the gas sensor 1B and the like as compared with a case where the rear end surface is smaller than the front end surface. Specifically, in a case where a rear end surface of the spacer 70B is larger than a front end surface of the elastic body 50, it is easy to set the contact area A2(B) between the rear end surface and the front end surface to 25% or more of an entire area of the front end surface of the elastic body, as compared with a case where the rear end surface is smaller than the front end surface.

Further, in the gas sensor 1B, a rear end surface of the spacer 70B may be smaller than a front end surface of the elastic body 50. However, as described above, the contact area A2(B) between the spacer 70B and the elastic body 50 is desirably 25% or more of an entire area of a front end surface of the elastic body 50. Further, the distance L2(B) from the center of gravity CG2(B) of a contact surface between the elastic body 50 and the spacer 70B to the extension line of the axis is desirably set to be sufficiently small, and specifically, the distance L2(B) is desirably set to be within 2 mm.

### [Feature]

As described above, the gas sensor (1, 1A, 1B) according to one aspect of the present invention includes the sensor element 10, the terminal fitting 30, the ceramic housing 60, the tubular body 20, the elastic body 50, and the spacer (70, 70A, 70B). The sensor element 10 extends in the axial direction, has the detection unit 11 on the front end side, and has the connector electrode 12 on the rear end side. The terminal fitting 30 extends in the axial direction and has the element contact portion 31 on the front end side, and the element contact portion 31 is electrically connected to the connector electrode 12 of the sensor element 10. The ceramic housing 60 houses the connector electrode 12 of the sensor element 10 and the element contact portion 31 of the terminal fitting 30. The tubular body 20 is a tubular member in which the sensor element 10, the terminal fitting 30, and the ceramic housing 60 are arranged, and an opening end is formed. The elastic body 50 is arranged so as to seal an opening end (an opening end on the rear end side) of the tubular body 20.

The spacer (70, 70A, 70B) according to one aspect of the present invention is arranged between the ceramic housing 60 and the elastic body 50 in the axial direction of the sensor element 10 (gas sensor (1, 1A, 1B)). The spacer is in contact with the ceramic housing 60 at a front end surface, and in contact with the elastic body 50 at a rear end surface. In the spacer according to one aspect of the present invention, Young's modulus of at least a front end portion including a front end surface is 80 GPa or more. For example, Young's modulus of each of the entire spacers 70 and 70B is 80 GPa or more. Further, the spacer 70A includes the front end portion 71A having Young's modulus of 80 GPa or more and the rear end portion 72A having Young's modulus of less than 80 GPa.

The present inventors have considered that it is possible to prevent the ceramic housing 60 from biting into the elastic body 50 by arranging the spacer (70, 70A, 70B) between the ceramic housing 60 and the elastic body 50. In view of the above, in the gas sensor according to one aspect of the present invention, the spacer (70, 70A, 70B) is arranged between the ceramic housing 60 and the elastic body 50.

The present inventors have further considered that in order to prevent the ceramic housing 60 from biting into a member arranged on the rear end side of the ceramic housing 60, it is effective to sufficiently harden a portion on the front end side in the axial direction of the member arranged on the rear end side. Here, as described above, in the gas sensor according to one aspect of the present invention, the spacer (70, 70A, 70B) is arranged between the ceramic housing 60 and the elastic body 50. In view of the above, in order to prevent the ceramic housing 60 from biting into the spacer (70, 70A, 70B) (in particular, a front end portion of the spacer), the present inventors have obtained hardness (softness) to be given to the front end portion of the spacer by an experiment (example described later). As a result, the present inventors have confirmed that by setting Young's modulus of the front end portion of the spacer described above to 80 GPa or more, it is possible to remarkably prevent the ceramic housing 60 from biting into the spacer (in particular, a front end portion of the spacer) as compared with a case of setting the Young's modulus to less than 80 GPa.

In the gas sensor according to one aspect of the present invention, the ceramic housing 60 is in contact with the spacer (70, 70A, 70B) arranged on the rear end side of the ceramic housing 60, particularly, a front end surface of the spacer (70, 70A, 70B). Then, Young's modulus of a front end portion including a front end surface of the spacer (70, 70A, 70B) is 80 GPa or more, which is sufficient hardness capable of remarkably preventing the ceramic housing 60 from biting into the spacer (in particular the front end portion of the spacer).

For this reason, in the gas sensor according to one aspect of the present invention, an event such as that “the ceramic housing 60 bites into the spacer described above arranged on the rear end side of the ceramic housing 60 in a state of being inclined from the axial direction, and such a state is fixed” does not occur.

Therefore, the gas sensor according to one aspect of the present invention can prevent the ceramic housing 60 from biting into a member (that is, the spacer (70, 70A, 70B)) arranged on the rear end side of the ceramic housing 60 in a state of being inclined from the axial direction.

### [Variation]

Although the embodiment of the present invention is described above, the above description of the embodiment is merely an example of the present invention in all respects. Various improvements and modifications may be made to the above embodiment. With respect to each constituent element of the above embodiment, omission, replacement, and addition of the constituent element may be appropriately performed. Further, a shape and dimension of each constituent element of the above embodiment may be appropriately changed according to the embodiment. For example, a change below can be made. Note that, in description below, a similar reference numeral is used for a constituent element similar to that of the above embodiment, and description is appropriately omitted for a point similar to the above embodiment. Variations below can be appropriately combined.

In the gas sensor (for example, the gas sensors 1, 1A, or 1B described above) according to one aspect of the present invention, a shape of the spacer (70, 70A, 70B) arranged between the elastic body (50) and the ceramic housing (60) is not particularly limited. The spacer may have, for example, a cylindrical shape, a truncated cone shape, or a shape in which one or more cylinders and one or more truncated cones are combined and arranged in the axial direction. Further, in at least a part of the spacer, a length in a direction orthogonal to the axial direction (for example, a diameter in a direction orthogonal to the axial direction) may continuously or discontinuously change along the axial direction. Furthermore, in the spacer, a front end surface and a rear end surface may have substantially the same shape, an area of a front end surface may be smaller than an area of a rear end surface, or an area of a front end surface may be larger than an area of a rear end surface.

Furthermore, a front end surface of the spacer may be similar to a rear end surface of the ceramic housing, for example, a front end surface of the spacer and a rear end surface of the ceramic housing may be substantially equal in area and shape. Further, a front end surface of the spacer and a rear end surface of the ceramic housing may be different from each other, that is, the front end surface and the rear end surface may be different from each other in at least one of area and shape.

Similarly, a rear end surface of the spacer may be similar to a front end surface of the elastic body, and for example, a rear end surface of the spacer and a front end surface of the elastic body may be substantially equal in area and shape. Further, a rear end surface of the spacer and a front end surface of the elastic body may be different from each other, that is, the rear end surface and the front end surface may be different from each other in at least one of area and shape.

### EXAMPLE

In order to verify an effect of the present invention (in particular, durability performance of the terminal fitting), the inventors of the present invention produced a gas sensor according to Levels (Examples) 1 to 4 below, and conducted a highly accelerated limit test (HALT test). However, the present invention is not limited to the Levels (Examples) below.

TABLE 1

| | Member in contact with ceramic | | | |
|---|---|---|---|---|
| | housing at rear end of ceramic | Young's | | |
| Level | housing | modulus | | Evaluation |
| 1 | Elastic body | 7 | GPa | X |
| 2 | Spacer | 65 | GPa | X |
| 3 | Spacer | 80 | GPa | ◯ |
| 4 | Spacer | 120 | GPa | ◯ |

A gas sensor of Level 1 is the conventional gas sensor as disclosed in JP 2014-196917 A described above, that is, a gas sensor in which a spacer is not arranged between a ceramic housing and an elastic body. Specifically, in the gas sensor of Level 1, an elastic body is arranged on the rear end side in an axial direction of the gas sensor (axial direction of a sensor element) of a ceramic housing, and in particular, the elastic body is in contact with the ceramic housing at the rear end of the ceramic housing.

Each of the gas sensors of Levels 2 to 4 is a gas sensor including a configuration (member) illustrated in FIG. 1, that is, a gas sensor in which a spacer is arranged between a ceramic housing and an elastic body. Specifically, in the gas sensor of Levels 2 to 4, a spacer is arranged on the rear end side in an axial direction of a ceramic housing, and in particular, the spacer is in contact with the ceramic housing at a rear end of the ceramic housing. However, the gas sensors of Levels 2 to 4 differ from one another in Young's modulus of a spacer in contact with a ceramic housing at a rear end of the ceramic housing.

That is, in the gas sensor of Level 2, Young's modulus of a spacer is 65 GPa, that is, the spacer in contact with a ceramic housing at a rear end of the ceramic housing has Young's modulus of less than 80 GPa. On the other hand, in the gas sensors of Levels 3 to 4, Young's modulus of a spacer is 80 GPa or more, that is, a spacer in contact with a ceramic housing at a rear end of the ceramic housing has Young's modulus of 80 GPa or more. Specifically, in the gas sensor of Level 3, Young's modulus of a spacer is 80 GPa. Further, in the gas sensor of Level 4, Young's modulus of a spacer is 120 GPa.

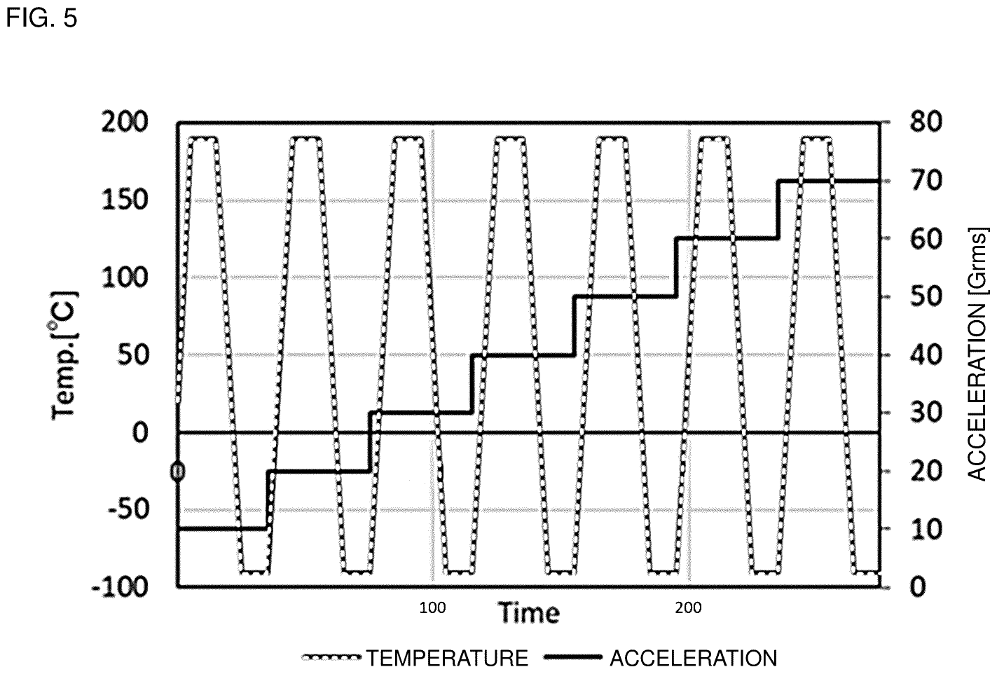

The present inventors conducted a highly accelerated limit test (HALT test) below for the gas sensor according to each of Levels 1 to 4 in order to compare durability performance of a terminal fitting attached to a ceramic housing and connected to a sensor element. That is, a HALT test in which each of a temperature condition and an acceleration condition in a sequence illustrated in FIG. 5 was performed on the gas sensor according to each of Levels 1 to 4 (a plurality of the gas sensors according to the levels).

FIG. 5 is a graph showing each change (sequence) in a temperature condition and an acceleration condition in a HALT test (durability comparison test) performed by the present inventors on the gas sensor according to each of Levels 1 to 4. In the graph exemplified in FIG. 5, a change in a temperature condition is indicated by a dotted line, and as exemplified in FIG. 5, a temperature condition is changed in a range of “−90° C.” to “190° C.”. Further, in the graph illustrated in FIG. 5, a change in an acceleration condition is indicated by a solid line, and as exemplified in FIG. 5, an acceleration condition is changed in a range of “10 Grms” to “70 Grms”.

Such a HALT test was performed on a plurality of the gas sensors according to the levels, and after the HALT test was performed (for example, at a time point of time=200, in other words, at a time point of acceleration=40 Grms), presence or absence of breakage of a terminal fitting attached to a ceramic housing was checked. That is, the above-described HALT test was performed on a plurality of the gas sensors according to Level 1, and after the HALT test was performed, presence or absence of breakage of a terminal fitting of a plurality of the gas sensors was checked. Similarly, the above-described HALT test was performed on a plurality of the gas sensors according to Levels 2 to 4, and after the HALT test was performed, presence or absence of breakage of a terminal fitting of a plurality of the gas sensors was checked.

In Table 1, evaluation of “◯ (extremely good)” indicates that a terminal fitting attached to a ceramic housing was not damaged in all of a plurality of the gas sensors according to the levels. Evaluation of “× (poor)” indicates that breakage of a terminal fitting was confirmed in one or more of a plurality of the gas sensors according to the levels.

Note that, in the HALT test described above, temperature and acceleration (vibration) stress exceeding an actual use condition of the gas sensor are applied to a plurality of the gas sensors according to the levels. For this reason, even if evaluation in Table 1 is “× (poor)”, it should be noted that such evaluation of “×” does not mean that the gas sensor at the level evaluated as “×” is unsuitable for actual use.

The conventional gas sensor of Level 1 (the gas sensor in which no spacer is arranged between a ceramic housing and an elastic body) was evaluated as “X (poor)”. Further, the gas sensor of Level 2 (the gas sensor in which a spacer is arranged between a ceramic housing and an elastic body, and Young's modulus of the spacer is less than 80 GPa) was evaluated as “× (poor)”.

On the other hand, all of the gas sensors of Levels 3 to 4 (the gas sensor in which a spacer is arranged between a ceramic housing and an elastic body, and Young's modulus of the spacer is 80 GPa or more) were evaluated as “◯ (extremely good)”.

Therefore, the present inventors have confirmed an event below by the HALT test described above and the test result (evaluation). That is, the present inventors have confirmed that a possibility of breakage of a terminal fitting attached to a ceramic housing can be reduced by arrangement of a spacer between the ceramic housing and an elastic body and Young's modulus of the spacer set to 80 GPa or more.

### REFERENCE SIGNS LIST

1, 1A, 1B Gas sensor

10 Sensor element

11 Detection unit

12 Connector electrode

20 Tubular body

30 Terminal fitting

31 Element contact portion

50 Elastic body

60 Ceramic housing

70, 70A, 70B Spacer

1. A gas sensor comprising:
a sensor element that extends in an axial direction, has a detection unit on a front end side, and has a connector electrode on a rear end side;
a terminal fitting that extends in the axial direction and has an element contact portion electrically connected to the connector electrode on a front end side;
a ceramic housing that houses the connector electrode and the element contact portion;
a tubular body in which the sensor element, the terminal fitting, and the ceramic housing are arranged, and an opening end is formed;
an elastic body arranged to seal the opening end; and
a spacer that is arranged between the ceramic housing and the elastic body in the axial direction, is in contact with the ceramic housing at an end surface on a front end side in the axial direction, is in contact with the elastic body at an end surface on a rear end side in the axial direction, and has Young's modulus of 80 GPa or more at least at a front end portion including an end surface on the front end side.

2. The gas sensor according to claim 1, wherein in the spacer, Young's modulus of a rear end portion including an end surface on the rear end side is smaller than Young's modulus of the front end portion.

3. The gas sensor according to claim 1, wherein a contact area between the spacer and the ceramic housing is 3 mm² or more.

4. The gas sensor according to claim 1, wherein an area of a portion in contact with the spacer in an end surface on the front end side of the elastic body is 25% or more of an entire area of an end surface on the front end side of the elastic body.

5. The gas sensor according to claim 1, wherein a distance from a position of a center of gravity of a portion in contact with the ceramic housing on the end surface on the front end side of the spacer, which is a center of mass when mass is virtually uniformly distributed to a portion in contact with the ceramic housing on an end surface on the front end side of the spacer, to a straight line obtained by extending an axis of the sensor element in the axial direction is within 2 mm.

6. The gas sensor according to claim 1, wherein a distance from a position of a center of gravity of a portion in contact with the spacer on an end surface on the front end side of the elastic body, which is a center of mass when mass is virtually uniformly distributed to a portion in contact with the spacer on the end surface on the front end side of the elastic body, to a straight line obtained by extending an axis of the sensor element in the axial direction is within 2 mm.

7. The gas sensor according to claim 1, wherein a material of the elastic body is fluororubber.

8. The gas sensor according to claim 1, wherein at least a portion of the spacer is made from ceramics.

9. The gas sensor according to claim 2, wherein a contact area between the spacer and the ceramic housing is 3 mm² or more.

10. The gas sensor according to claim 2, wherein an area of a portion in contact with the spacer in an end surface on the front end side of the elastic body is 25% or more of an entire area of an end surface on the front end side of the elastic body.

11. The gas sensor according to claim 2, wherein a distance from a position of a center of gravity of a portion in contact with the ceramic housing on the end surface on the front end side of the spacer, which is a center of mass when mass is virtually uniformly distributed to a portion in contact with the ceramic housing on an end surface on the front end side of the spacer, to a straight line obtained by extending an axis of the sensor element in the axial direction is within 2 mm.

12. The gas sensor according to claim 2, wherein a distance from a position of a center of gravity of a portion in contact with the spacer on an end surface on the front end side of the elastic body, which is a center of mass when mass is virtually uniformly distributed to a portion in contact with the spacer on the end surface on the front end side of the elastic body, to a straight line obtained by extending an axis of the sensor element in the axial direction is within 2 mm.

13. The gas sensor according to claim 2, wherein a material of the elastic body is fluororubber.

14. The gas sensor according to claim 2, wherein at least a portion of the spacer is made from ceramics.
